(19) United States
(12) Patent Application Publication
(10) Pub. No.: US 2026/0080631 A1
(43) Pub. Date: Mar. 19, 2026

(54) DEFINING TASKS IN SCENES USING DELTA INFORMATION FOR ROBOTICS SYSTEMS AND APPLICATIONS

(71) Applicant: NVIDIA Corporation, Santa Clara, CA (US)

(72) Inventors: Eric Bowman, Provo, UT (US); Paul Cutsinger, Redmond, WA (US); Linxi Fan, San Jose, CA (US); Yuke Zhu, Austin, TX (US)

(21) Appl. No.: 18/890,612

(22) Filed: Sep. 19, 2024

(51) Int. Cl. G06T 19/00; B25J 9/16

(52) U.S. Cl. CPC G06T 19/006; B25J 9/1671; G06T 2200/24; G06T 2210/32; G06T 2219/024

(57) ABSTRACT

Embodiments of the present disclosure relate to defining tasks in scenes using delta information. In operation, some embodiments first receive or generate scene data. Some embodiments then generate delta information indicating one or more changes within the scene data. For example, responsive to user input, particular embodiments generate the delta information, such as a delta layer. Generating such delta information is useful in various applications such as robotics, simulation, graphics rendering, gaming, autonomous driving, or the like. For instance, with respect to robotics, some embodiments store data corresponding to the delta information as at least part of a task definition for a robotic task. Some embodiments then responsively cause or train one or more real-world robotic components represented by one or more virtual robotic components to perform a task in a real-world scene represented by a virtual scene based on the delta information and the task definition.

### BACKGROUND

Various technologies such as robotics, graphics rendering, gaming, and autonomous and semi-autonomous machine technologies have significant challenges in creating and managing complex scenes (e.g., virtual representations of real-world 3D environments). For example, some of these technologies have difficulty creating and managing intricate scenes with numerous assets or objects, each with unique geometries, textures, materials, light transport properties, and animations. This is partially because it is difficult to ensure consistency and coherence across different tools and platforms used in production pipelines. Further, different software applications often use proprietary formats for generating scenes, leading to difficulties in data exchange and collaboration. The lack of standardization hinders seamless integration between different stages of production or operation.

### SUMMARY

Embodiments of the present disclosure relate to defining tasks (e.g., robotic tasks) in scenes (e.g., a virtual environment) using delta or diff information. Delta or diff information refers to any data structure and/or data (e.g., functions, routines, etc.) that at least include an indication of one or more changes to a scene, object, feature, etc. In operation, some embodiments first receive or generate scene data. For example, in some embodiments the scene data corresponds to a base layer representative of a primary definition of a scene in an Open Universal Scene Description (USD) format. Such scene data, for instance, may be a virtual scene indicating one or more virtual robotic components.

Some embodiments then generate delta information indicating one or more changes within the scene data. For example, using the illustration above, some embodiments receive an indication that a user has dragged an object from one position to another in the virtual scene, which represents movement of the one or more virtual robotic components. Responsive to such dragging, particular embodiments then generate the delta information, such as a delta layer. A delta layer only stores changes, making it efficient to represent different states or versions of a scene without duplicating the entire dataset. For example, using the illustration above, the delta layer would only store changes of the specific coordinates or locations that the virtual robotic components have moved to but no other assets or objects in the scene, such as the ground the robotic components are traversing on, or the like. Accordingly, instead of storing the entire scene each time a change is made, a delta layer may only record the differences from a base layer or previous state layer, making it efficient in terms of memory consumption, latency, and/or other computing resources.

Generating such delta information is useful for a variety of applications such as robotics, simulation, graphics rendering, gaming, autonomous or semi-autonomous driving, and/or the like. For instance, with respect to robotics, some embodiments store data corresponding to the delta information as at least part of a task definition for a robotic task. A robotic task definition is a description of the specific actions, sequences, and/or objectives that one or more robotic components need to perform to complete a given task. For example, the task definition may describe a task where a robot needs to retrieve a box from a shelf in a warehouse and deliver it to a packing station. In other words, the delta information is mapped to or otherwise associated with at least a portion of a particular robotic task definition. Some embodiments then responsively cause one or more real-world robotic components represented by the one or more virtual robotic components to perform a task in a real-world scene represented by the virtual scene based on the delta information and the task definition. For example, a real-world robot may take, as input, an OpenUSD file (which includes the delta information) to perform the real-world task of picking or placing a package to or from a location by reading the delta information. Some embodiments can then measure the real-world robot's task adherence to the task definition. For example, various embodiments compare the expected positions (as indicated in the delta information) and actual positions of the real-world robot to determine how accurately the task was performed.

### BRIEF DESCRIPTION OF THE DRAWINGS

The present systems and methods for defining tasks (e.g., robotic tasks) in scenes (e.g., a virtual environment) using delta or diff information is described in detail below with reference to the attached drawing figures, wherein:

FIG. 1 illustrates an example robotic task pipeline, in accordance with some embodiments of the present disclosure;

FIG. 2A is a screenshot of an example user interface page illustrating an initial base layer state of a sphere object and ground object in an OpenUSD format, according to some embodiments;

FIG. 2B is a screenshot of an example user interface page illustrating the coding structure of the base layer of FIG. 2A, according to some embodiments;

FIG. 2C is a screenshot of an example user interface page illustrating the generation or unmuting of the delta layers corresponding to a task definition of the objects and of FIG. 2A, according to some embodiments;

FIG. 2D is a screenshot of an example user interface page illustrating the coding structure of the delta layer of FIG. 2A, according to some embodiments;

FIG. 3 is a schematic diagram illustrating that a robot can read one or more OpenUSD files to execute one or more tasks and/or that the robot's tasks may be used to generate the OpenUSD file(s), according to some embodiments;

FIG. 4 is a flow diagram of an example method for using delta information to define a task definition for one or more robotic components, according to some embodiments;

FIG. 5 is a flow diagram of an example method for generating a delta layer, according to some embodiments;

FIG. 6 is a flow diagram of an example method for training one or more virtual robots in a simulation, according to some embodiments;

FIG. 7A is an illustration of an example autonomous vehicle, in accordance with some embodiments of the present disclosure;

FIG. 7B is an example of camera locations and fields of view for the example autonomous vehicle of FIG. 7A, in accordance with some embodiments of the present disclosure;

FIG. 7C is a block diagram of an example system architecture for the example autonomous vehicle of FIG. 7A, in accordance with some embodiments of the present disclosure;

FIG. 7D is a system diagram for communication between cloud-based server(s) and the example autonomous vehicle of FIG. 7A, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

As described above, various technologies have significant challenges in creating and managing scenes. For example, traditional robotic tasks have been defined using a variety of proprietary formats (e.g., proprietary XML or JSON schemas) and methods, each tailored to specific robots or applications. These formats are commonly used to define the actions and parameters for robotic tasks. Each manufacturer typically develops its own schema, leading to a lack of standardization across different systems. An example of such formats include custom binary formats, which are used for performance efficiency but are often opaque and difficult to integrate with other systems without detailed knowledge of the format. Some existing technologies use custom scripts, which are created to translate task definitions between different formats. A “task definition” is a description of the specific actions, sequences, and/or objectives that an entity (e.g., a robot or virtual asset) needs to perform to complete a given task. For example, the task definition may describe a task where a robot needs to retrieve a box from a shelf in a warehouse and deliver it to a packing station. The existing approaches are labor-intensive, error-prone, and not scalable as the complexity and number of robotic systems increase. The absence of a unified format for defining robotic tasks makes it challenging to integrate robots from different manufacturers. This lack of standardization hinders collaboration and interoperability.

Further, developers and researchers spend considerable time and effort creating and maintaining translation tools to convert between different task definition formats. This process is not only time-consuming but also prone to programming errors. For example, there is a higher likelihood of manual coding errors. Developers often create custom scripts or tools to translate task definitions between different formats (e.g., XML to JSON, JSON to binary). The manual coding involved in these translations is highly susceptible to typographical errors, logical mistakes, and oversight. Further, each translation tool may implement data mappings differently, leading to inconsistencies. For instance, the way a “pick” action robot task is defined in one format might differ slightly from another, causing discrepancies when tasks are translated. In an illustrative example, a task's speed parameter might be interpreted in different units (e.g., meters per second vs. centimeters per second) across formats, leading to incorrect execution speeds. There may also be version control problems. Without a unified format, managing different versions of task definitions across various formats becomes cumbersome. Version control issues arise when changes are not consistently tracked and updated across all formats. For example, an update to a task might be applied in the JSON version but missed in the XML version, causing inconsistencies during execution. Existing technologies also often struggle to accommodate new technologies and data types, such as advanced 3D sensor data (e.g., LiDAR) in autonomous vehicle applications. Incorporating these new data types typically requires significant modifications to the existing formats.

Various embodiments provide one or more technical solutions that have technical effects relative to these existing robotics, graphics rendering, gaming, autonomous or semi-autonomous machine, and/or other technologies. Various embodiments relate to defining tasks in scenes using delta or diff layers. In operation, particular embodiments first receive or generate scene data representative of an environment. For example, in some embodiments the scene data corresponds to a base layer representative of a primary definition of a scene in an Open Universal Scene Description (USD) format. OpenUSD is an open-source framework developed for interchange of 3D graphics data. It is designed to be highly scalable and capable of representing complex scenes and assets in a unified format. OpenUSD provides the ability to: compose Scenes by combining various assets into complex scenes with flexibility, edit non-destructively by making changes to scenes without altering the original data, and supports various types of data. OpenUSD represents not only geometry and materials but also animations, cameras, lights, and even more abstract concepts such as layered and procedural data. OpenUSD is useful in technologies like visual effects, animation, and robotics, where interoperability and the ability to manage complex scenes are crucial. It supports the storage and retrieval of not just images and video, but also 3D sensor data such as LiDAR and RADAR, making it a versatile standard for various applications.

After creation of such scene data, some embodiments then receive a request to change a first portion (e.g., a particular object or asset) of the scene data. For example, where an initial scene includes a virtual representation of a robot with a ball on the ground, particular embodiments receive a natural language (e.g., Large Language Model (LLM)) prompt from a user that states, “have the robot place the ball on the table.” In another example, various embodiments receive an indication that a user has dragged an object at a user interface in the scene from one position to another. In other examples, such change request can include a request to alter the position of an object, update a robot's path, change the material properties of an object in the environment, and/or the like. As such, one or more inputs may be received (e.g., textual, physical (e.g., via a mouse, joystick, controller, keyboard, etc.), audible, etc.) that cause movement of one or more components of a robotic device (e.g., a humanoid robot, a robotic arm or manipulator, a warehouse robot, an autonomous or semi-autonomous vehicle or machine, etc.).

At least partially responsive to receiving such request to change a first portion of scene data, some embodiments automatically generate a delta layer. A delta layer may only store changes (e.g., with respect to the robotic component, an object in the scene, and/or other objects/features), making it efficient to represent different states or versions of a scene without duplicating the entire dataset. In some embodiments, the delta layer may only correspond to an individual object of interest—e.g., one or more components of the robot—while in other embodiments, a delta layer may reflect changes to each object/feature in the scene for a given instance. For example, each object may have its own delta layers for each instance, while in other embodiments, a single delta layer may reflect multiple objects/features for a given instance of time/scene change. Accordingly, instead of storing the entire scene each time a change is made (which existing technologies do), a delta layer only records the differences from a base layer or previous state. Delta layers can be applied sequentially on top of the scene data to reconstruct the full scene. This hierarchical approach allows for modular and flexible scene composition. By recording only changes, delta layers reduce the amount of data that needs to be stored and processed, making scene management more efficient. Since delta layers only store changes, they significantly reduce the amount of data that needs to be stored to a storage device compared to duplicating the entire scene for each update. This leads to lower memory consumption in computers and more efficient use of storage resources relative to existing technologies. Instead of saving multiple copies of a scene with minor changes, as existing technologies do, delta layers may only record the differences, allowing for a compact representation of scene variations.

Employing delta layers also improves computational performance. For example, robots that load delta layers have faster execution times than loading multiple full scene files because only the base layer and the relevant changes need to be processed. Applying incremental changes is also computationally less intensive than reconstructing the entire scene from scratch, leading to improved performance during scene updates.

In some embodiments, based on the scene data and the generating of the delta layer, a robot is caused or trained (e.g., using reinforcement learning) to perform a task in the environment. For instance, in some embodiments, the change leading to the generation of the delta layer is representative of a task definition (or individual delta layers of a plurality of delta layers may illustrate one increment of an overall task definition) describing one or more actions that a robot needs to perform in order to complete a task. In response to the robot performing the task in the environment, some embodiments then generate a second delta layer representative of the robot performing the task in the environment. Particular embodiments then measure, by comparing the first delta layer with the second delta layer, the task's adherence to the task definition. For example, where a user initially moves a robotic arm to pick up a ball and place it within a virtual scene, one or more delta layers may be generated (e.g., at a desired interval-such as time-based or amount of movement-based) to represent the task. Then, during training or deployment, a real-world or virtual robot may perform the same task, thereby generating delta layers, and a comparison may be made between the human-imposed delta layers and the robotics automated delta layers to reinforce the desired behavior on the robot. As a result, the robot may be trained to perform the task according to the human imposed task definition using the delta layer comparisons.

In an illustrative example of such robotic task adherence and related functionality, the scene may first be initialized, where a warehouse environment is represented by a USD file (e.g., warehouse_scene.usd) containing all relevant elements. The first portion of the scene data includes dynamic elements related to the robot's task, such as a virtual representation (e.g., a digital twin) of the robot and movable items. The second portion includes static elements like virtual representations of shelves, walls, and fixed machinery. A request is then made to move a virtual box from virtual shelf A to a virtual packing station. The request specifies the new position of the box and the path the robot should take. The delta layer may then be generated, which indicates the change (e.g., delta_layer1=create_delta_layer(‘move_box_request.usd’, changes={‘box_position’: new_position_on_shelf, ‘robot_path’: defined_path}). The content of the delta layer only includes indications of changes related to the box's position and the robot's path. The task definition is the delta layer that represents the task of moving the box.

After such first delta layer is generated, the robot's control system then interprets the first delta layer and performs the task. As the robot moves the actual box in the real-world, a second delta layer is generated to reflect the actual changes (e.g., delta_layer2=create_delta_layer (‘move_box_performed.usd’, changes={box_position’:final_position_at_packing station, ‘robot_path’:actual_path_taken}). Various embodiments then compare the first delta layer (task definition) with the second delta layer (task execution). For example, various embodiments compare the expected and actual positions of objects and the robot to determine how accurately the task was performed. To do this, some embodiments extract position values from the first delta layer, and extract the target position values of objects and the robot. From the second delta layer, some embodiments extract the actual position values after the task execution. Particular embodiments then calculate the deviations by computing the differences between the expected and actual position values. Particular embodiments then evaluate the accuracy by determining if the deviations are within acceptable tolerances (e.g., tolerance=0.01, which is an example tolerance in meters). In another example of task adherence, some embodiments compare the expected and actual times for task completion to measure timing adherence. In yet another example, some embodiments compare the planned path with the actual path taken by the robot to measure adherence to the planned trajectory. The generation and comparison of delta layers enable precise measurement of task adherence, ensuring that robots perform tasks accurately as defined.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated sensor data may be used to identify objects or features within the simulation environment, and may use this information to perform operations (e.g., pick and place) associated with the virtual machine within the environment. These simulated operations may be used to test performance of the underlying algorithms, systems, and/or processes prior to deploying them in the real-world. In some instances, the simulation may be used to generate synthetic training data—e.g., training data including task definitions from within the simulation. The synthetic training data (in addition to or alternatively from real-world data) may then be processed to determine task definitions or to train a robot to perform tasks within a simulated or real-world environment. In any example, such as where a simulation environment is used for testing, validation, training, etc., the simulation environment and/or associated training data may be rendered or otherwise generated using one or more light transport algorithms-such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems-such as systems for testing, validating, training (e.g., machine learning models, neural networks, etc.), and/or other tasks related to automotive, robot, machine, or other applications.

### Example Robotic Task Pipeline

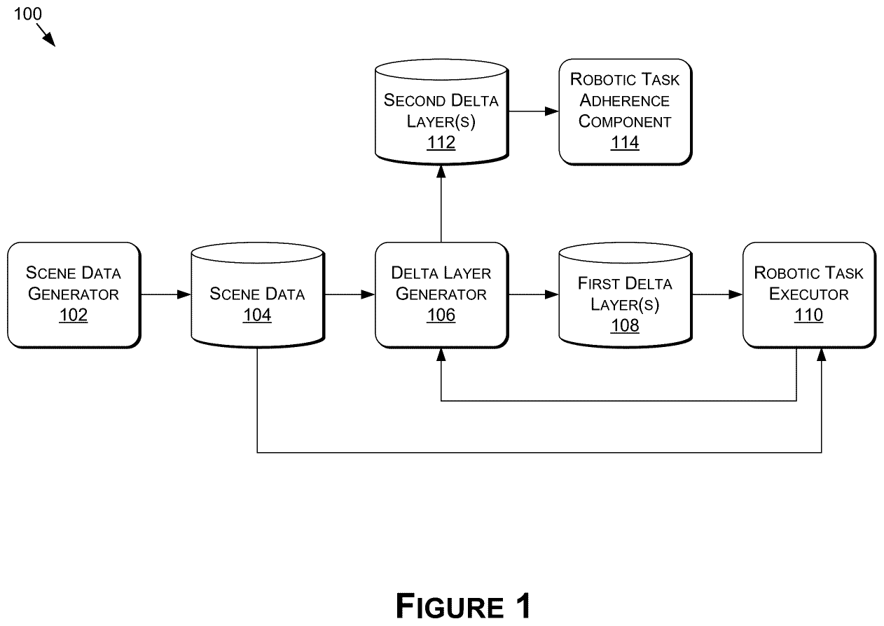

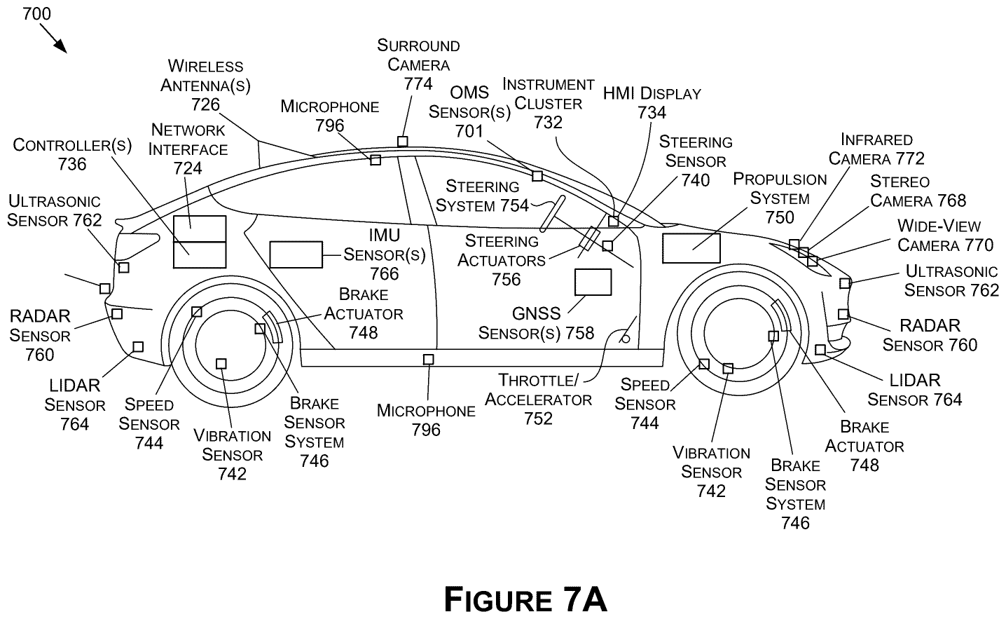

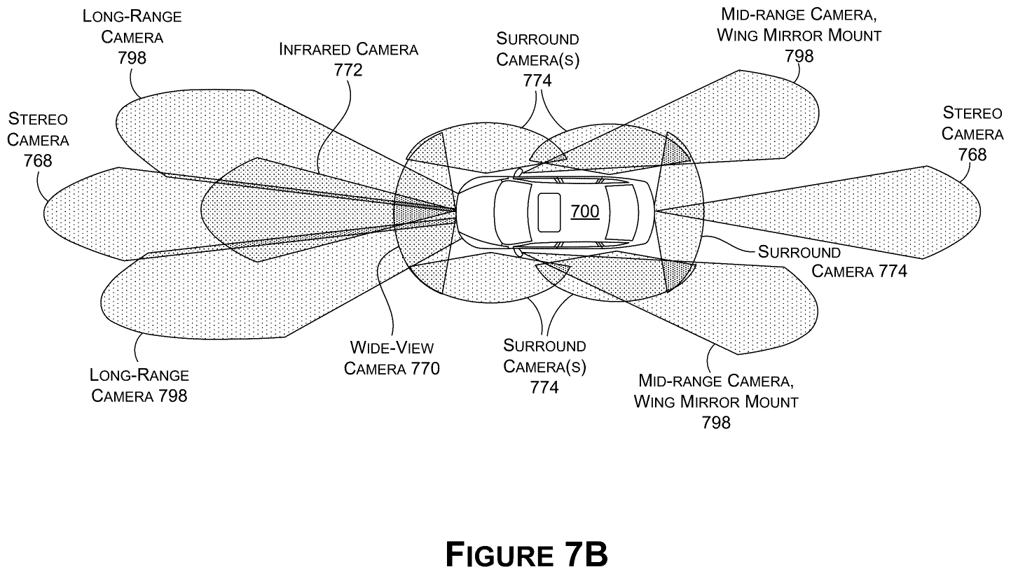

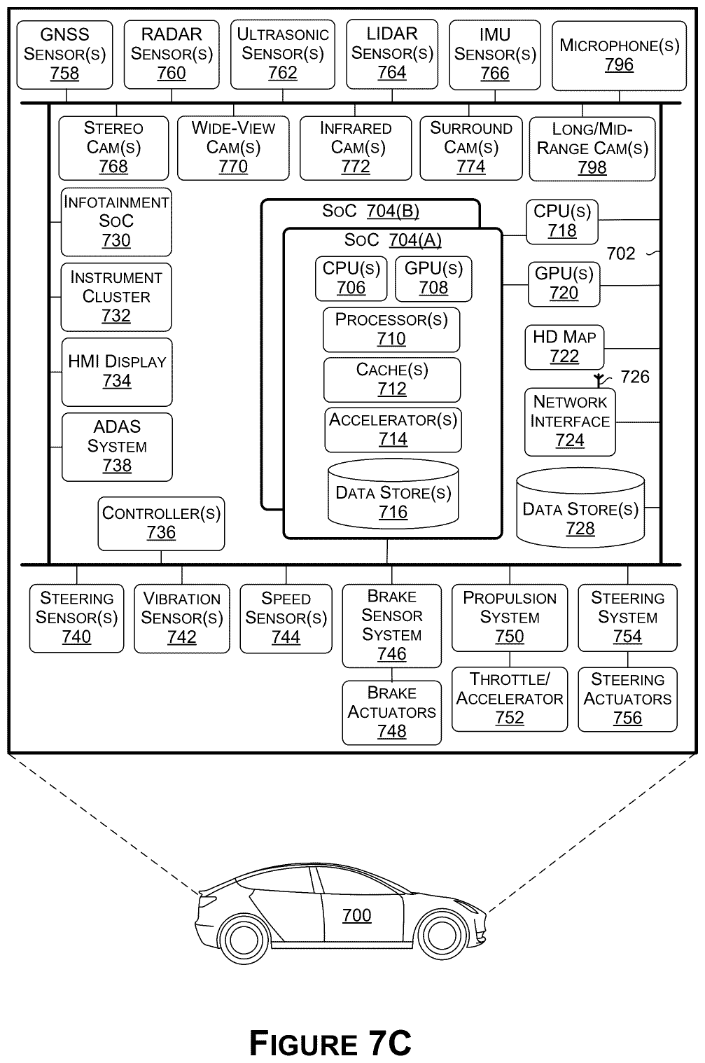

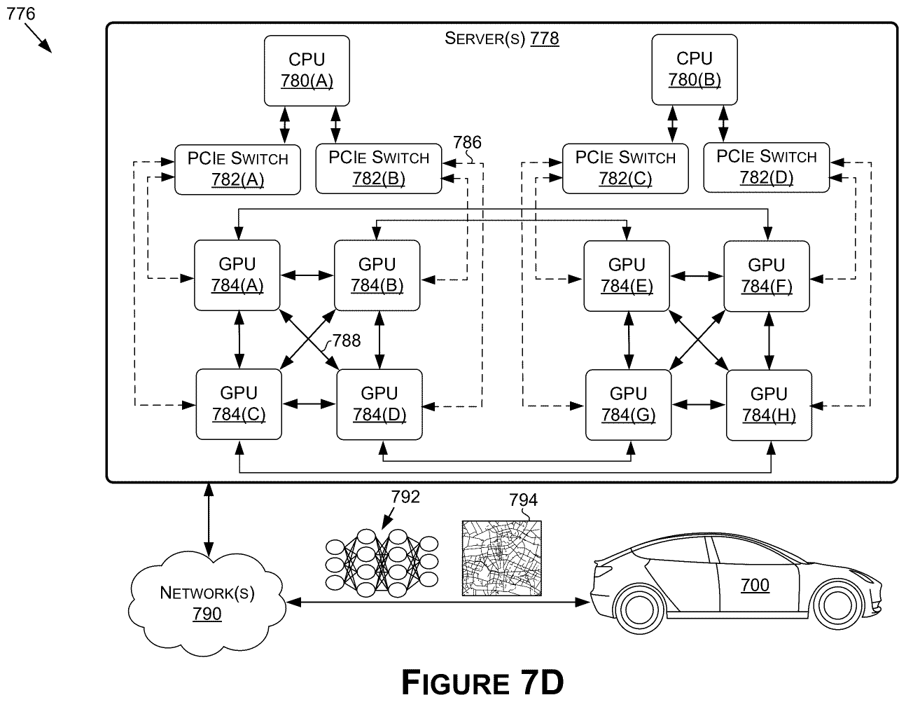

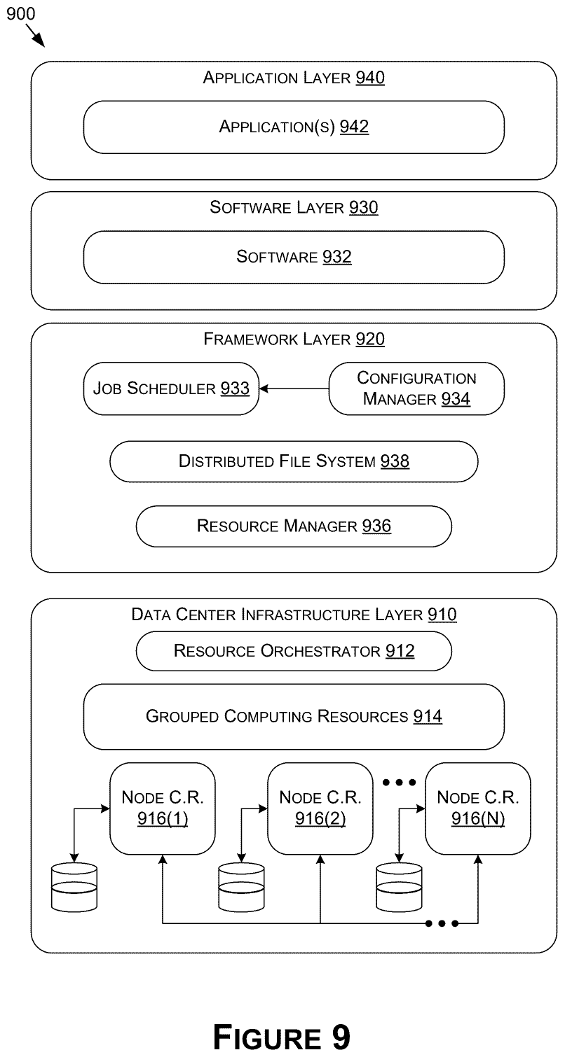

With reference to FIG. 1, FIG. 1 illustrates an example robotic task pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 700 of FIGS. 7A-7D, example computing device 800 of FIG. 18, and/or example data center 900 of FIG. 9. In some embodiments, the pipeline 100 includes fewer components as illustrated in FIG. 1. For example, in some embodiments, the pipeline 100 only includes a scene data generator 102, scene data 104, a delta layer generator 106, and one or more first delta layers 108 (and no other components). In these embodiments, these components are suitable for use outside of robotic contexts, such as in rendering, autonomous vehicles, gaming, and the like, and as described in more detail below.

In the embodiment illustrated in FIG. 1, the pipeline 100 includes a scene data generator 102, which generates scene data 104, a delta layer generator 106, which generates a first set of one or more delta layers 108, a robotic task executor 110, a second set of delta layers 112, and a robotic task adherence component 114. The pipeline 100 is generally responsible for executing and measuring a robotic task via the generation of multiple delta layers.

The scene data generator 102 is responsible for generating scene data 104. To generate the scene data 104, various embodiments employ scene authoring techniques to generate an environment. Scene authoring includes, modeling, texturing, shading, lighting, animation, and/or simulation. Modeling is the process of creating 3D objects, structures, characters, and other assets that populate the scene data (e.g., a vehicle driving scene via the use of 3D modeling functionality, such as BLENDER). Texturing and shading includes applying textures and materials (e.g., albedo material maps) to the 3D models to give them realistic appearances. This can include functions like applying textures and defining how materials react to light (e.g., via a Spatially-varying Bidirectional Reflectance Distribution Function (SVBRDF)). A Bidirectional Distribution Function (BRDF) is a function used to describe the reflectance properties of a real-world object surface (or how light interacts with a surface). “Spatially-varying” BRDF means that reflectance properties change across a surface depending on the position of the corresponding object in relation to a light source, which affects the lighting (e.g., intensity, absorption, or scattering), the color of the object, the texture of the object, or other geometric features of the object (e.g., roughness, glossiness, etc.).

In an illustrative example of scene authoring, it can be utilized to generate one or more virtual robots and surrounding environment simulating one or more real-world robots as they traverse through an environment. For instance, scene authoring techniques can generate a digital twin of a robot and the surrounding environment of the robot. In the context of simulation, a digital twin typically refers to a highly detailed and realistic digital representation of a real-world object (e.g., a robot or ego-machine), its real-world components, and/or real-world conditions (e.g., lighting) by collecting and integrating data from one or more sources, such as sensors, IoT devices, and other data streams, to create a detailed and dynamic digital model. This digital model may mimic one or many real-world component characteristics, behavior, and attributes in real-time or near-real-time as the component (e.g., robot) traverses through an environment. In another example, scene authoring can include generating a virtual representation of an intersection, natural lighting visual data (representative of a sun at a particular time), and/or other virtual representations, such as pedestrians, roads, traffic signs, and traffic lights. In another example, scene authoring may produce simulated sensor data via, such as a map or simulated image of one or more scenes, as derived from a virtual radar, virtual GPS, virtual LiDAR, and/or virtual camera.

To build such digital twins, in some embodiments, data is collected from various sensors (e.g., camera, LiDAR, radar). These sensors can capture information about physical properties, such as temperature, humidity, light, sound, and more. 3D scanners, LiDAR (Light Detection and Ranging), and photogrammetry, or other sensors may be used to capture detailed geometric information. This data is used to create a 3D model of the object or environment. Once the sensor data is collected, it may be processed and transformed into a format that can be used to create a digital twin. This may involve data cleaning, calibration, and normalization. Geometric data acquired from scanning and imaging can be used to create a 3D model of the cockpit. This model can include the shape, size, and structure of the real-world cockpit. Simulation data, such as environmental conditions and sensor readings, can be integrated into the digital twin to make it more realistic and functional.

To indicate reflections and other visual characteristics of the scene data, material properties and textures may be assigned to the 3D model. This includes specifying how light interacts with different surfaces. For instance, embodiments may define materials to be reflective, transparent, or translucent. In some embodiments, digital twins are designed to provide real-time updates. This means that as the real-world object or environment changes, the digital twin reflects those changes. For instance, if lighting conditions change, the digital twin should adjust its visual representation accordingly. In some embodiments, digital twins are integrated with simulation functionality that may accurately replicate the behavior and performance of the real-world counterpart. This allows users to interact with and analyze the digital twin in different scenarios.

In some embodiments, the scene data 104 is part of a platform (e.g., OMNIVERSE from NVIDIA Corporation) that enables collaborative 3D content creation, simulation, and design across various industries. Collaboration may be facilitated through a range of features and tools that allow teams to work together in a shared virtual environment. For example, some features of such platform may be a shared virtual environment. A shared virtual environment is an environment where multiple team members can collaborate on 3D projects (e.g., robot task execution) in real-time. In some embodiments, such platform enables real-time collaboration, allowing team members to work together simultaneously on the same project. This means that changes made by one team member are immediately visible to others. For example, if one team adjusts a scene for a robotic task, such change will be immediately available to other teams. In some embodiments, teams may easily share 3D assets, models, textures, and materials within the platform. In some embodiments, assets may be stored in a central library, making them readily accessible to all collaborators. This streamlines asset management and ensures consistency across projects. In some embodiments, such platform offers version control capabilities, allowing teams to keep track of changes and revisions to their 3D scenes and assets. This ensures that team members can easily review and revert to previous versions if necessary. In some embodiments, the platform is extensible, allowing developers to create custom extensions and plugins to enhance the platform's functionality, tailor it to specific project needs, or integrate with other tools.

In some embodiments, the scene data 104 is additionally or part of OpenUSD. OpenUSD (Universal Scene Description) is an open-source framework developed by Pixar Animation Studios for the efficient interchange of complex 3D graphics data. It provides a robust and flexible system for describing and managing the components and states of 3D scenes, making it a useful tool for industries like animation, visual effects, virtual reality, and robotics. One of the core components of OpenUSD is Primitives (Prims), which are the fundamental building blocks of a USD scene. Prims can represent various entities, including geometric shapes, lights, cameras, and more abstract elements like groups or layers. There are several types of Prims, such as Geometric Prims (e.g., meshes, surfaces, and volumes), Transform Prims (e.g., nodes that define spatial transformations like translations, rotations, and scales), Light Prims (representations of light sources with properties like intensity and color), and Camera Prims (virtual cameras that capture scenes from specific viewpoints.

OpenUSD includes attributes, which are properties or data associated with prims, such as positions, orientations, colors, materials, and custom user-defined attributes. The types of attributes include Scalar Attributes, which are single values (e.g., float, int), and vector Attributes, such as arrays of values (e.g., vector3 for position). There are also various layers. A “base layer,” for example contains the initial, comprehensive definition of a scene, including all prims and attributes. Composition arcs include references, payloads, variants, and inherits. References allow one USD file to include the contents of another USD file, promoting reuse and modularity. Payloads are similar to references but can be loaded or unloaded on demand, managing memory and performance efficiently. Variants provide multiple variations of a prim, enabling different configurations within the same scene. Inherits allow prims to inherit properties from a base prim, ensuring consistency and reusability.

A “stage” in OpenUSD is a top-level container for a USD scene, representing the full scene graph. It manages the loading, composition, and evaluation of all prims and layers to construct the complete scene. In OpenUSD, scenes are composed of multiple layers that can be combined and modified independently. Components can be reused across different scenes, reducing redundancy and simplifying management. OpenUSD is also designed to manage large and complex datasets efficiently, making it suitable for high-end applications. As an open-source framework, OpenUSD is widely supported across different tools and platforms, facilitating collaboration and data exchange. Cross-platform compatibility ensures that scene data can be used consistently across various applications and systems. Further, users can define custom attributes and prim types to meet specific needs, ensuring flexibility. Open USD also provides support for advanced data types. In other words, it can handle a wide range of data, from simple geometric shapes to complex 3D sensor data like LiDAR. OpenUSD also facilitates version control by allowing incremental changes to be tracked and managed. Multiple users can also work on different parts of a scene independently, with changes captured in separate layers.

In an illustrative example of an animation production pipeline, artists first create 3D models using geometric prims. Materials and textures are applied using attributes. Scene assembly occurs when different assets (characters, props, environments) are assembled into a scene using references and payloads. Positions, orientations, and scales are set using transform prims. Animators then create key frames for character movements, stored as attributes on the prims.

Different animation variations (e.g., walk, run) are managed using variants. Lighting and camera setup is then performed-light sources are added and configured using light prims. Virtual cameras are set up using camera prims to capture the scene from different angles. With respect to final rendering: scenes are rendered layer by layer, allowing for efficient management of changes and updates. Rendered layers are then combined to produce the final image or animation. Alternatively or additionally, in some embodiments, the scene data 102 represents a simulated environment provided the neural networks (e.g., DNNs) or other methods.

In some embodiments, the scene data generator 102 generates the scene data 104 additionally or alternatively through one or more light transport simulation algorithms, such as ray tracing and/or path tracing. For example, particular embodiments first define the geometry, position, and materials of objects in the scene. Materials describe how objects interact with light, including properties like color, reflectivity, transparency, and texture. Various embodiments place virtual light sources in the scene, specifying their type (e.g., point light, directional light, spotlight) and properties (intensity, color, position). Various embodiments set a virtual camera's position and direction to determine the viewpoint from which the scene will be rendered. Various embodiments define the camera's field of view, which influences the perspective of the scene. For each pixel on the screen, some embodiments generate a ray that originates from the camera and passes through the pixel. This ray represents the path that light would take to reach the camera. With respect to ray-object intersection, some embodiments check if the generated ray intersects with any objects in the scene. This involves solving mathematical equations to determine where and if the ray hits an object. Various embodiments identify the closest intersection point along the ray's path, as this determines the first surface that the ray encounters.

At the intersection point, some embodiments retrieve the properties of the surface, such as color, normal vector (perpendicular to the surface), and material characteristics. Some embodiments compute the lighting at the intersection point by considering all light sources in the scene. This typically involves calculating the following components: ambient lighting (general illumination present in the scene, simulating indirect light), diffuse lighting (light scattered in all directions from the surface, depending on the angle between the light direction and the surface normal), specular lighting (reflection of light in a specific direction, creating highlights and shiny spots on the surface), and shadows by determining if the intersection point is in shadow by casting additional rays (shadow rays) towards the light sources. If an object obstructs the light, the point is in shadow.

If the material is reflective, some embodiments generate new rays that bounce off the surface in the mirror direction. Trace these reflection rays recursively to determine their contribution to the final color. If the material is transparent or translucent, generate rays that pass through the surface, bending according to the material's refractive index. Some embodiments combine the contributions from direct lighting, shadows, reflections, and refractions to compute the final color for the pixel. In some embodiments, this process involve recursively tracing multiple rays and combining their results. After calculating the color for each pixel, some embodiments assemble these colors to create the final image or scene data 104. The result is a rendered image that simulates realistic lighting and material interactions.

Continuing with the pipeline 100 of FIG. 1, the delta layer generator 106 takes as input, the scene data 104 and a request to change the scene data 104 to generate a first set of one or more delta layers 108. Generating delta layers involves capturing the changes made to an existing scene or dataset, such as the scene data 104. Instead of storing the entire scene repeatedly, delta layers store only the modifications or differences from a base layer or other scene data. This approach is efficient in terms of memory and processing, as it focuses on incremental updates rather than duplicating the entire scene. The delta layer generator 106 defines the boundaries of a delta layer based on the detected changes, encapsulating all modifications that occur within a specific time period, event, and/or property threshold. For example, some embodiments detect movement, force changes, sensor readings, color changes, reflectance changes, or any predefined event beyond a threshold. In another example, a delta layer is defined to capture all changes within a specific event or time interval.

In an illustrative example, for a task, a robot needs to move from its current position to a designated point, pick up an object, and place it at a new location. In order to generate a delta layer, various embodiments first define the base layer. The base layer contains the initial state of the environment, including the robot's starting position and the positions of all objects. For instance, “base_layer.usd” defines the initial positions of the robot and objects. Various embodiments then capture changes for each task step. Each task step (e.g., moving to the object, picking up the object, placing the object) involves changes to the scene, which are captured in separate delta layers. Delta layers record only the changes, such as new positions or states.

In an illustrative example, the initial state or base layer indicates that a virtual robot is at position (0, 0, 0), and the object is at position (5, 0, 0): {“robot_position”: [0, 0, 0], “object_position”: [5, 0, 0]}. The first delta layer indicates the virtual robot moving to an object—the robot moves to position (5, 0, 0). The first delta layer captures this change. (e.g., {“robot_position”: [5, 0, 0]}. Likewise a second delta layer (in the first set of delay layers 108) indicates that the virtual robot picks up the object (e.g., {“object_state”: “picked”}). The third delta layer (of the first set of delta layers 108) indicates that the virtual robot moves to position (10, 0, 0) with the object. The third delta layer captures this movement (e.g., {“robot_position”: [10, 0, 0]}). A fourth delta layer (of the first set of delta layer(s) 108) indicate that the virtual robot places the object at position (10, 0, 0). Delta layer 4 captures the state change of the object (e.g., “{'object_state”: “placed”}).

In various embodiments, the first set of delta layers 108 are represented mathematically as changes to a base or initial state as follows:

$${State}_{i} = Base State {\sum }_{j = 1}^{i} + {Δ}_{j}$$

where Stateᵢ is the state after applying the i-th delta layer, “Base State” is the initial state defined by the base layer, and Δⱼ is the j-th delta layer representing changes to the state. Accordingly, delta layers efficiently capture and apply incremental changes to a base state, optimizing memory usage and processing. In a robotic task, this method allows for precise control and tracking of the robot's actions, ensuring accurate and efficient task execution.

The robotic task executor 110 takes, as input, the first set of one or more delta layers (e.g., the first delta layer described above) and the scene data 104 in order to cause one or more real-world robotic components to perform a task. In some embodiments, the robotic task executor 110 represents logic hosted in a robot. In other embodiments, the robotic task executor 110 represent logic hosted at a remote device, such as a server. The robotic task executor 110 sends a control signal to the robot to cause the robot to perform one or more tasks according to task definition(s) defined by the delta layer(s) 108 generated by the delta layer generator 106. In other words, the robot, for example, performs a computer read of the scene data 104 and the first delta layer(s) 108 and responsively performs one or more real-world tasks as specified in the first delta layer(s) 108. The robotic task executor 110 accordingly interprets and applies the first delta layer(s) 108 to control a robot's actions in real-time. It reads the scene data 104 (e.g., a base layer) and sequentially applies the first set of one or more delta layers 108 (e.g., the first delta layer, then the second delta layer, then the third delta layer described above) to guide the robot through a series of tasks.

As another example, the delta layers defining the task definition may be used to teach or train the robot to perform the task in the virtual world again and/or to perform the task in the real-world. For example, one the task is defined in the delta layers, the movements of the robot in an automated attempted to perform the same task may be compared against the task definition from the delta layers. In such an example, where the robot is attempting to perform the same task in the simulation, the delta layers generated by the automated robot may be compared against the delta layers from the task definition to train the robot (e.g., the underlying software/hardware) to perform the task as close to or matching the definition of the task from the task definition.

In some embodiments, such as where the task definition from the delta layers is used to perform robotic actions in the real-world, a conversion may be learned from delta layer information associated with the simulation to actual movements of a robot in the real-world. As such, when performing the task in the real-world, the movements of the robot in the real-world may be converted to similar format as the delta layers for comparison and evaluation, or vice versa, where the delta layers are converted to a real-world format for comparison to the real-world movements of the robot.

Using the illustration above, for example, the robotic task executor 110 first loads a base layer or the initial state of the environment. Then the robotic task executor 110 reads and interprets the first, second, and third delta layers containing task modifications. The robot then executes the actions defined in the delta layers. In some embodiments, the robot includes a sensor feedback handler, which adjusts actions based on real-time sensor data. In some embodiments, in response to the robot performing one or more actual real-world tasks, the robotic task executor 110 sends a signal back to the delta layer generator 106 to generate the second set of one or more delta layers 112 to record the actual changes made by the robot in the environment. These additional delta layer(s) 112 serve to document the real-world execution of tasks, capturing the differences between the planned actions (as defined in the original first delta layer(s) 108) and the actual outcomes. This process helps in monitoring, verifying, and adjusting the robot's performance. The second set of one or more delta layer(s) 112 thus record the real-world positions, states, and conditions after the robot performs its tasks. This ensures that the actual execution is documented for analysis and future reference.

Using the illustration above, for example, the robot moves but ends up slightly off the target position, which is indicated by this delta layer: {“actual_robot_position”: [4.9, 0, 0]//Slight deviation from target.}. The robot successfully picks up the object-{“actual_object_state”: “picked”}. However, the robot's path is slightly different, possibly due to an obstacle, as indicated in the following delta layer of 112: {“actual_robot_position”: [10.1, 0, 0]//Slight deviation from target}. The robot then places the object slightly off the intended position: {“actual_object_position”: [10.1, 0, 0], “actual_object_state”: “placed”}. In other words, the robot reads and applies the original first delta layer(s) 108 to determine its planned actions. Then the robot performs the tasks as defined, while sensors and feedback systems monitor the actual execution. For example, a LiDAR sensor mounted on a robot can scan the area to detect any unexpected obstacles and help the robot navigate around them in real-time. In another example, a camera mounted on the robot can be used to check if a robot has successfully grasped an object and if it is placing it at the correct location. In yet another example, an Inertial Measurement Unit (IMU) can detect if a robot arm is moving smoothly or if there are any unexpected jerks or deviations from the planned motion. A force sensor in a robotic gripper can detect if the grip is too tight or too loose and adjust accordingly.

As the robot performs each action, the actual outcomes are recorded in new delta layer(s) 112. These layers document the real-world positions and states, capturing any deviations from the planned actions. In other words, as the robot performs each task as defined by each delta layer in the first set of delta layer(s) 108, sensors and feedback systems (e.g., LiDar and camera) monitor the robot's actions and the resulting changes in the environment. These monitored changes are recorded as a corresponding an additional delta layer in 112, capturing the actual state after each task or change/delta layer. In an illustrative example, the robot reads the first delta layer in 108 indicating what the robots position should be. Responsively, sensors on the robot read the real-world position of the robot and responsively generate another delta file in 112 indicating the robot's real-world position.

As described above, different sensors or feedback systems can be used to measure and/or evaluate actual robot tasks. LiDAR sensors, for example, emit laser beams and measure the time it takes for the light to reflect back from surfaces. This data is used to create a detailed 3D map of the environment. LiDAR can detect obstacles, measure distances, and ensure the robot follows the planned path without collisions. Computer vision cameras also capture visual data from the robot's surroundings, which is processed using computer vision algorithms to recognize objects, track movements, and interpret scenes. Cameras can measure and/or verify the robot's actions, such as picking up an object, and ensure it is performing tasks accurately. IMUs measure the robot's acceleration, orientation, and angular velocity using accelerometers and gyroscopes. IMUs help monitor the robot's movements and ensure it maintains stability and correct orientation during tasks. Force/Torque Sensors measure the forces and torques applied to the robot's joints or end-effector. Force/torque sensors can ensure the robot applies the correct amount of force when interacting with objects, preventing damage to delicate items. For example, a force sensor in a robotic gripper can detect if the grip is too tight or too loose and adjust accordingly. Proximity sensors detect the presence of nearby objects without physical contact, using technologies like infrared, ultrasonic, or capacitive sensing. These sensors help prevent collisions and ensure safe navigation in cluttered environments. For example, ultrasonic sensors can detect obstacles close to the robot, allowing it to stop or reroute to avoid collisions. Tactile sensors measure touch, pressure, and texture, often using arrays of pressure-sensitive elements. These sensors provide feedback on the robot's interaction with objects, ensuring proper handling and manipulation. For example, tactile sensors on a robotic gripper can sense the texture and firmness of an object, adjusting the grip strength accordingly.

Responsive to the second delta layer(s) 112 being generated, the robotic task adherence component 114 then compares the planned changes (original delta layer(s) 108) with the actual changes (additional delta layer(s) 112) to verify task adherence. The robotic task adherence component 114 does this by identifying discrepancies between expected and actual outcomes to improve accuracy and performance. Error handling and adjustment is made to use the differences recorded in the additional delta layers to detect errors or deviations. Some embodiments then adjust future actions (e.g., of the real-world robot) or refine task definitions based on the analysis of these discrepancies. Some embodiments modify the robot's future actions to correct for any detected errors. For example, if the robot is consistently overshooting its target position, the system can adjust the robot's movement parameters. Some embodiments additionally or alternatively refine task definitions by updating the task definitions to better account for the real-world behavior of the robot. For instance, if an object is harder to grasp than anticipated, the task definition or delta layer change in 108 can be refined to include a more precise gripping action. By systematically comparing planned and actual changes and adjusting accordingly, the robot's accuracy and performance can be continuously improved. The process creates a feedback loop where the outcomes of one task execution inform the next, leading to progressively more accurate and efficient robotic behavior.

The following is an illustrative example, with a robot moving an object from one place to another. The initial task definition and execution is as follows: Base Layer: Initial positions and states of the robot and objects. The first set of delta layers 108 are as follows: move to object: {“robot_position”: [5, 0, 0]}; pick up object: {“object_state”: “picked”}; move to new location: {“robot_position”: [10, 0, 0]}; place object: {“object_state”: “placed”}. As the robot performs each action/task, sensors (e.g., Lidar, camera) record the actual positions and states, creating additional delta layers in 112: actual move to object: {“actual_robot_position”: [5.1, 0, 0]}; actual pick up object: {“actual_object_state”: “picked”}; actual move to new location: {“actual_robot_position”: [10.2, 0, 0]}; actual place object: {“actual_object_state”: “placed”}

The task adherence component 114 compares each planned change with the actual change to identify discrepancies: compare planned {“robot_position”: [5, 0, 0]} with actual {“actual_robot_position”: [5.1, 0, 0]}, compare planned {“object_state”: “picked”} with actual {“actual_object_state”: “picked”}, compare planned {“robot_position”: [10, 0, 0]} with actual {“actual_robot_position”: [10.2, 0, 0]}, compare planned {“object_state”: “placed”} with actual {“actual_object_state”: “placed”}.

The task adherence component 114 then identifies discrepancies. Discrepancy in the robot's position after moving: expected [5, 0, 0], actual [5.1, 0, 0]. Discrepancy in the robot's position after moving to the new location: expected [10, 0, 0], actual [10.2, 0, 0]. The robotic task adherence component 114 then uses these discrepancies to adjust future actions or refine task definitions, such as adjusting the robot's movement calibration to correct for the overshooting, or refining task definitions to include more precise positioning parameters or different movement strategies. Future task definitions or immediate corrective actions can be applied based on the feedback. For the next task execution, the robot's movement parameters might be adjusted to compensate for the observed deviations.

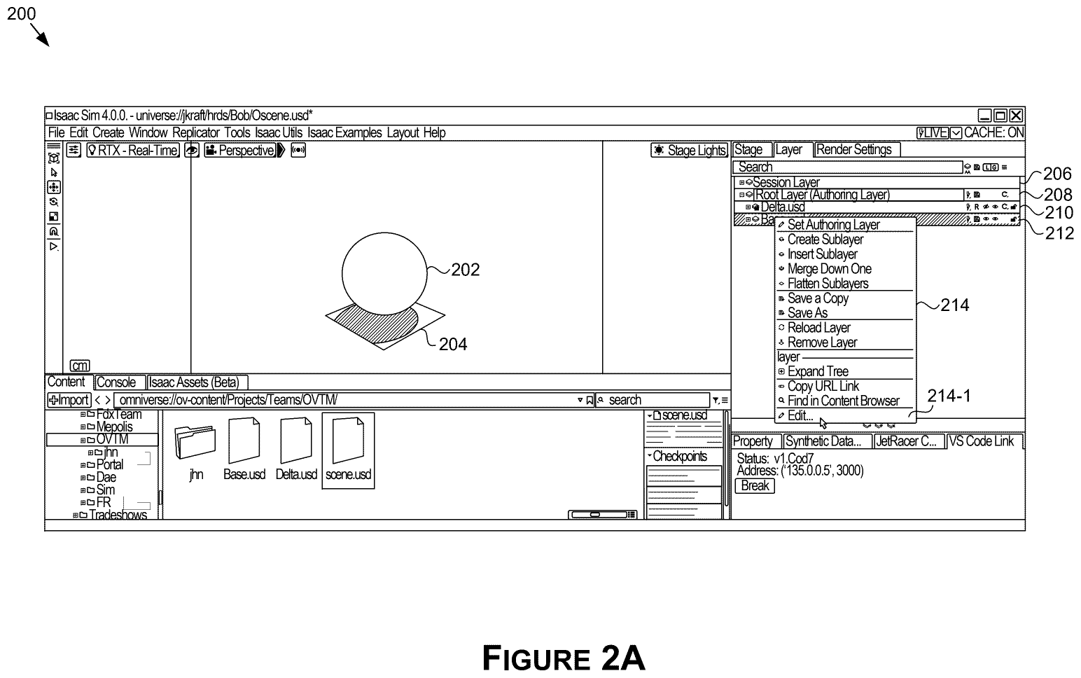

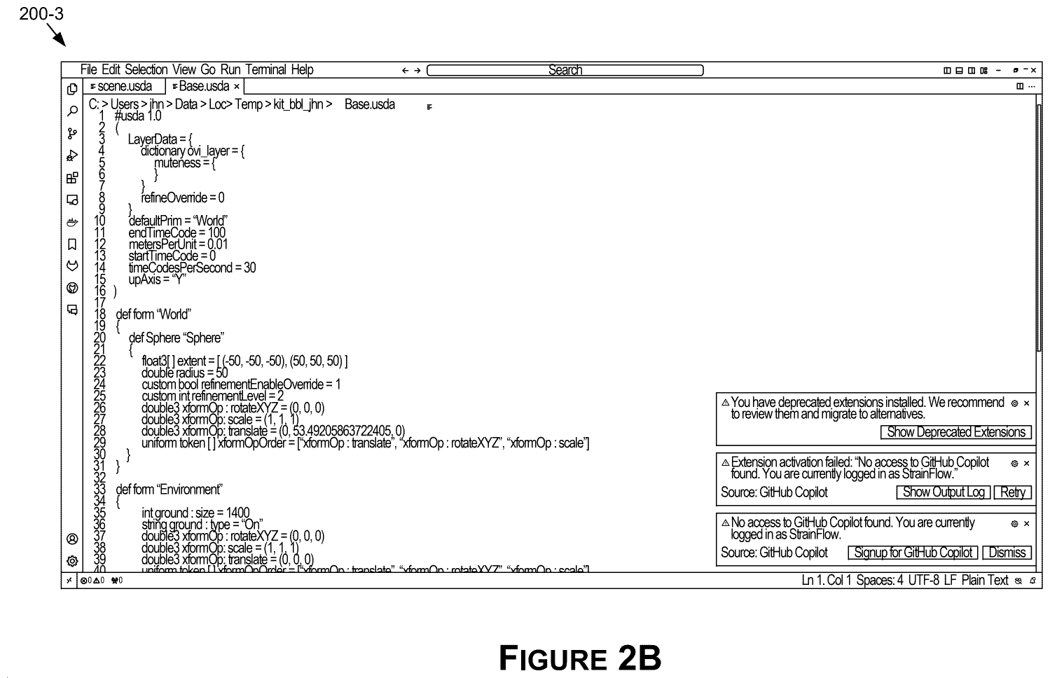

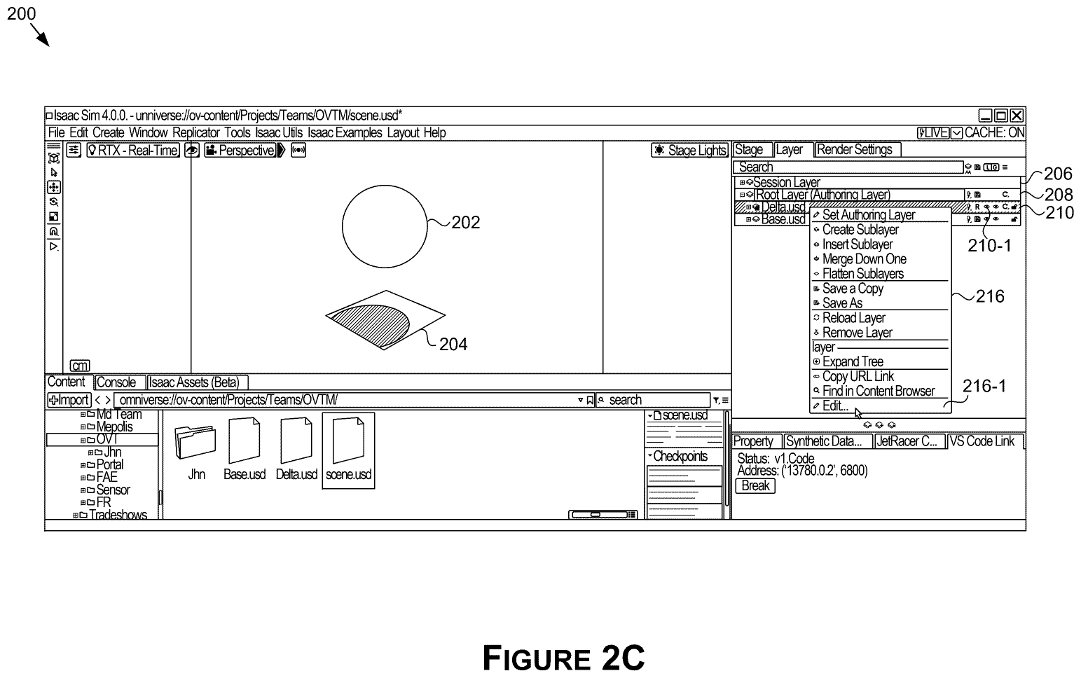

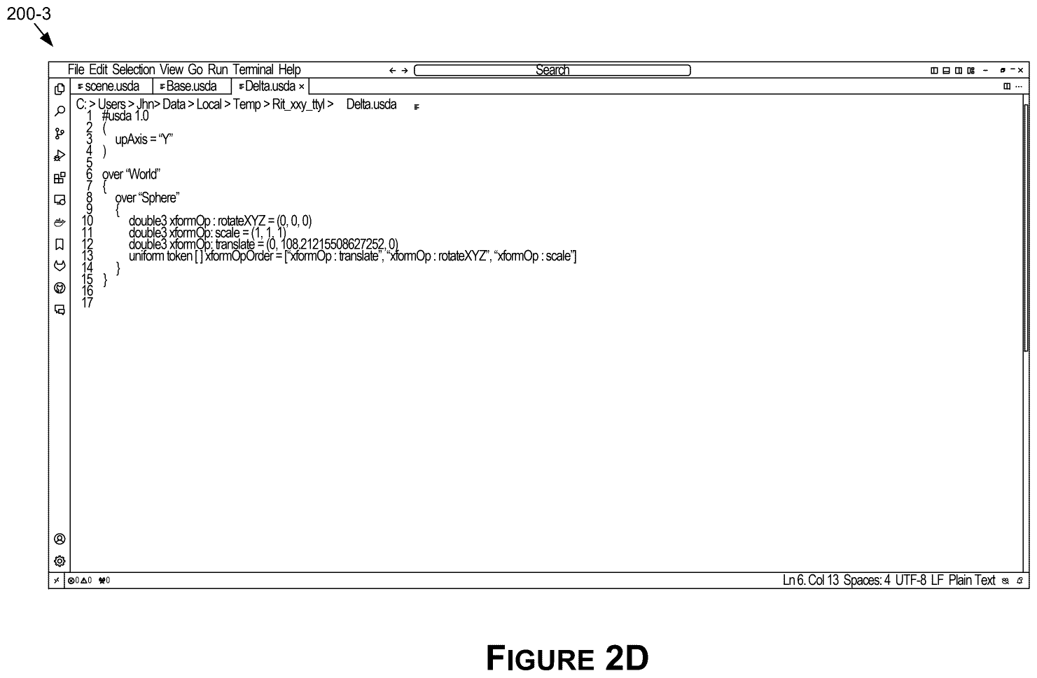

FIG. 2A is a screenshot of an example user interface page 200 illustrating an initial base layer state of a sphere object 202 and ground object 204 in an OpenUSD format, according to some embodiments. The page 200 includes a scene—the sphere 202, which is represented as being on top of or abutting the ground 202. The page further includes a right pane that includes indicators of a session layer 206, a root layer 208, a delta layer 210, and a base layer 212. A “session layer” corresponding to 206 session layer is a type of layer that exists to allow temporary, non-destructive modifications to a scene. The session layer enables users to make changes or adjustments to a scene without permanently altering the underlying data. This is particularly useful in collaborative environments or workflows where different users or applications need to make temporary modifications for testing, visualization, or interaction purposes. The session layer is used to apply changes that are meant to be temporary and not saved back to the base or other persistent layers. Examples include visualizing different configurations, testing animations, or adjusting parameters during a simulation. Changes made in the session layer do not overwrite or alter the original data in the base layers or other persistent layers. This ensures that the integrity of the original scene data is maintained. The session layer typically has a higher priority in the composition hierarchy. This means that changes in the session layer will override those in lower-priority layers during the session. This allows for effective temporary overrides without permanently affecting the underlying data.

Since the changes are not saved to the base or other layers, they can be easily discarded or reset. Users can experiment with different settings or configurations without worrying about making irreversible changes. For instance, users can make temporary changes to the scene for interactive visualization purposes, such as moving objects around, changing materials, or adjusting lighting. Engineers or artists can test different animations, physics simulations, or behavior adjustments in the session layer before committing any changes to the main layers. Multiple users can work on the same scene, making their own temporary adjustments in session layers without affecting each other's work or the original data.

A “root layer” corresponding to indicator 208 in OpenUSD is the topmost layer in the composition hierarchy that serves as the entry point for loading and managing a scene. It acts as the primary container that references other layers (e.g., base layer and delta layer) and assets, effectively organizing the entire scene structure. Accordingly, the root layer includes references to other USD layers and files, which can be base layers, sub-layers, or delta layers. It manages the composition of these layers, determining how they are combined and interpreted to form the complete scene. By acting as the top-level container, the root layer helps organize and structure the scene data in a coherent and manageable way. It allows for modular and hierarchical scene management, where different parts of the scene can be stored and handled in separate layers. The root layer is often stored as a USD file on disk, which can be loaded and referenced by various applications and workflows. It provides a persistent representation of the scene's structure and composition. In an illustrative example, the root layer can reference multiple asset files, such as models, textures, animations, and configurations, assembling them into a cohesive scene. Different teams or individuals can work on separate layers or assets, which are then referenced and composed in the root layer, facilitating collaborative scene creation and management. The root layer can be used in conjunction with version control systems to manage different versions of a scene, allowing for easy updates and modifications.

FIG. 2B is a screenshot of an example user interface page 200-1 illustrating the coding structure of the base layer of FIG. 2A, according to some embodiments. In some embodiments, in response to receiving an indication that a user has selected the “edit” element 214-1 of the pop-up window 214 of FIG. 2A, various embodiments cause presentation of the page 200-1. As illustrated in the user interface page 200-1, there are definitions of the sphere and ground corresponding to the visual representation of the sphere 202 and ground 204 objects and various properties associated with these, such as the coordinate position and size of the sphere 202 and ground 204 objects.

FIG. 2C is a screenshot of an example user interface page 200-2 illustrating the generation or unmuting of the delta layers corresponding to a task definition of the objects 202 and 204 of FIG. 2A, according to some embodiments. In some embodiments, in response to receiving an indication that a user has selected the mute layer button 210-1, the corresponding delta layer is unmuted. Consequently and automatically, the virtual ball 202 changes to a position (e.g., indicative of bouncing) higher relative to its position as indicated in FIG. 2A. In OpenUSD, muting and unmuting are features that allow users to control the visibility and influence of specific layers within a scene. This functionality helps manage complex scenes by selectively including or excluding certain layers from the final composed scene, without permanently deleting or modifying those layers. Muting a layer temporarily disables it, effectively making it invisible and removing its influence from the final composed scene. This allows users to focus on specific parts of the scene, debug issues, or compare different versions of the scene without the muted layer's data interfering. Unmuting a layer re-enables it, restoring its visibility and influence within the composed scene. This allows users to bring back the muted layer's data when needed, ensuring flexibility in scene management and editing. For example, if a specific layer is causing issues or unwanted effects in a scene, it can be muted to isolate the problem and test the scene without the layer's influence. In another example, artists can mute and unmute different lighting layers to compare how different lighting setups affect the scene. In yet another example, developers can mute layers that are not relevant to their current task, reducing complexity and allowing them to focus on specific parts of the scene.

In some embodiments, the mute layer button 210—need not be selected to cause presentation of the new changes to the sphere 202 and ground 204 as illustrated in FIG. 2C. Rather, in some embodiments, users can directly interface with the sphere object 202 and ground object 204. For example, in response to receiving an indication that the user has dragged (e.g., via a cursor click and hold) the sphere object 202 from its first location as indicated in FIG. 2A (being on the ground 204) to a second higher location as illustrated in FIG. 2C, particular embodiments cause a change in presentation of the objects 202 and 204 as illustrated by the change in objects 202 and 204 from FIG. 2A to FIG. 2C. Alternatively or additionally, various embodiments receive an indication that a user has manually generated the delta file by creating the coding structure in the page 200-3 of FIG. 2D, as described in more detail below.

FIG. 2D is a screenshot of an example user interface page 200-3 illustrating the coding structure of the delta layer of FIG. 2A, according to some embodiments. In some embodiments, in response to receiving an indication that a user has selected the “edit” element 216-1 of the pop-up window 216 of FIG. 2C, various embodiments cause presentation of the page 200-3. As illustrated in the user interface page 200-3, the delta layer only contains the changes, which represent a change in position of the sphere 202 from its location in FIG. 2A to its location as indicated in FIG. 2C. Notably, there is no class or object in the coding structure of the page 200-3 that describes the ground object 202 or any other property of the sphere 202 (e.g., color, reflectance property, etc.). This is because a user has only requested a change in position of the sphere 202, and no changes to any other properties of the original scene as illustrated in FIG. 2A.

To make such delta layer, an “over” coding element is implemented as illustrated in the coding structure of the page 200-3. The “over” element effectively overwrites the “world” prim (e.g., a class) by overwriting the “sphere” object by changing the position of the sphere object 204. In OpenUSD, an “over” is a feature that allows users to non-destructively modify or override properties of prims (primitive elements) without changing the original definition of those prims. This mechanism is useful for enabling flexible and scalable workflows, where modifications can be made at different stages of the pipeline without permanently altering the original data or scene. The “over” concept leverages the layered composition system in OpenUSD, where changes can be applied in higher-priority layers that override the values in lower-priority layers. This layering system ensures that the original data remains intact while allowing flexible modifications. Users, for example, can selectively override only the properties they need to change, leaving all other properties of the prim unaffected. This targeted approach reduces redundancy and maintains the efficiency of the data representation. “Overs” also facilitate collaborative workflows by allowing different users or teams to make modifications without interfering with each other's work. They are also useful for versioning, where different versions of a scene can be managed through selective overrides.

In an illustrative example, artists can override material properties to experiment with different looks for a model without changing the base geometry or textures (e.g., changing the color of a character's outfit in a higher layer without modifying the base model). In another example, animators can override specific animation curves or key frames to adjust a character's performance without altering the base animation data. In another example, embodiments adjust the arm movement of a character for a specific scene. In another example, lighting artists can override light properties such as intensity, color, or position to create different lighting setups for various shots or sequences (e.g., modifying the brightness of a light source for a dramatic effect in one particular scene).

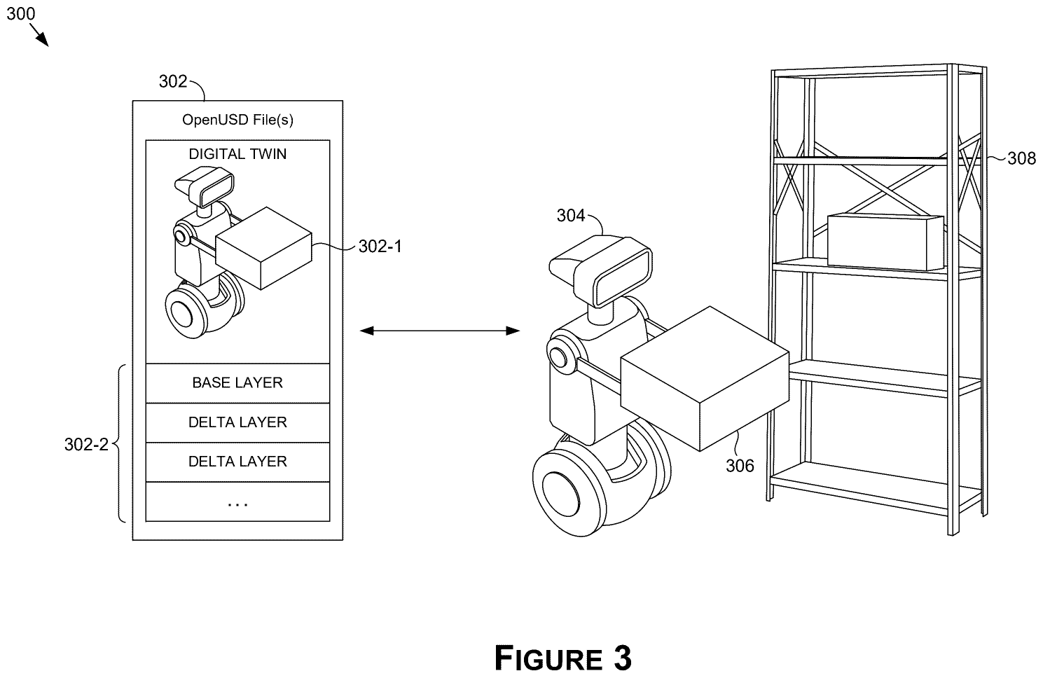

FIG. 3 is a schematic diagram illustrating that a robot 304 can read one or more OpenUSD files 302 to execute one or more tasks and/or that the robot 304's tasks may be used to generate the OpenUSD file(s) 302, according to some embodiments. The OpenUSD file(s) 302 includes a digital twin 302-1 (which is a virtual representation of the real-world robot 304) and the layers 302-2 (including a base layer and multiple delta layers). The layers 302-2 represent different properties of the digital twin 302-1 (e.g., position of virtual robot, position of virtual packages, color of package, etc.). In some embodiments, the layers 302-2 are essentially containers or data structures that hold different aspects or components of the scene, allowing for a modular and flexible approach to scene composition (whether in OPenUSD or not). In some embodiments, layers 302-2 act as containers that hold the scene data, such as geometry, materials, animations, and more. Each layer can contain a subset of the overall scene data. In some embodiments, layers enable a modular approach to building and managing scenes. Different layers can represent different components or aspects of the scene, which can be composed together to form the complete scene.

In some embodiments, the OpenUSD file(s) 302 is fed to the robot 304 as input so that the robot 304 can perform corresponding task(s). For instance, the robot 304's control system loads the USD file(s) 302, starting with the base layer and then sequentially applying the delta layers of the layers 302-2. The control system interprets the data from the USD file(s) 302, translating it into specific actions or tasks that the robot 304 needs to execute. The interpreted tasks are converted into commands sent to the robot's 304 actuators and sensors. In some embodiments, the robot 304's sensors provide real-time feedback, which is used to adjust the robot 304's actions if necessary.

With respect to FIG. 3, the Base Layer (base_layer.usd) defines the initial setup of the environment, including objects, such as the package 306, and their initial positions. Delta Layers (delta_layer_1.usd, delta_layer_2.usd, . . . ) specify changes or tasks, such as moving the package, picking it up, or navigating to a location, such as 308. Below is an example coding algorithm in Python that illustrates the robot 304 executing such base and delta layers:

```
# Function to load USD file
def load_usd_file(filename):
  with open(filename, ‘r’) as f:
    return json.load(f)
# Function to apply delta layer to the base layer
def apply_delta_layer(base_layer, delta_layer):
  for key, value in delta_layer.items( ):
    base_layer[key] = value
# Simulated robot class
class Robot:
  def _{——}init_{——}(self):
    self.position = [0, 0, 0]
  def move_to(self, position):
    print(f“Moving to position: {position}”)
    self.position = position
  def get_position(self):
    return self.position
  def at_position(self, position):
    return self.position == position
# Load base and delta layers
base_layer = load_usd_file(‘base_layer.usd’)
delta_layer_1 = load_usd_file(‘delta_layer_1.usd’)
# Apply delta layers
apply_delta_layer(base_layer, delta_layer_1)
# Create and command the robot
robot = Robot( )
move_command = base_layer[“move_to”]
robot.move_to(move_command)
# Simulate feedback and adjustment loop
while not robot.at_position(move_command):
  current_position = robot.get_position( )
  # Simulated check for obstacles
  if False: # replace with actual obstacle detection logic
    new_path = calculate_new_path(current_position,
    move_command)
    robot.follow_path(new_path)
  else:
    robot.move_to(move_command)
print(“Task completed.”)
```

Accordingly, feeding USD file(s) 302 with delta layers to the robot 304 involves preparing the file(s), loading them into the robot 304's control system, interpreting the data to generate commands, and then executing these commands while monitoring and adjusting based on sensor feedback. This process enables the robot 304 to perform complex tasks efficiently and accurately.

In some alternative embodiments, FIG. 3 illustrates that the real-world robot 304's actions are used to generate the digital twin—302-1 and/or corresponding layers 302-2. Creating a digital twin 302-1 of a real-world robot 304 involves capturing detailed data from the robot 304's sensors and actions, processing this data, and organizing it into base and delta layers with the OpenUSD file(s) 302. This allows for an accurate and dynamic virtual representation of the robot that can be updated and analyzed over time. For example, on-chip processors gather data from various sensors on the robot 304, such as position encoders, force sensors, cameras, LiDAR, IMUs, etc. Various embodiments then store or record the robot 304's actions, including movements, manipulations, and interactions with objects. Some embodiments perform filtering and cleaning by processing raw sensor data to remove noise and errors. Various embodiments then ensure that data from different sensors is synchronized. Some embodiments define the initial state of the robot 304 and its environment using the processed data. Various embodiments then generate the delta layers by capturing incremental changes or updates in the robot 304's state and actions over time.

In an illustrative example, position encoders on the robot 304 measure the position of joints. Force sensors on the robot 304 measure the force applied by the robot 304. Cameras and LiDAR capture visual and depth information. IMUs measure orientation and acceleration. After the sensor data is filtered and preprocessed, the base layer is created by using the preprocessed data to define the initial state of the robot 304 and its environment. Various embodiments then record incremental changes in the robot's state and actions as corresponding delta layers. This could be due to movements, interactions, or changes in the environment. For example, the delta layer may indicate a change in join position and force of the robot 304 (e.g., ({“timestamp”: “2024-08-01T12:05:00Z”, “robot”: {“kinematics”: {“joint_positions”: [50, 35, 65], “forces”: [5.5, 3.5, 4.5]}}). Some embodiments define the boundaries of a delta layer based on the detected changes, encapsulating all modifications that occur within a specific period, event, or threshold. In other words, for example, some embodiments detect changes that are significant enough to warrant capturing in a delta layer. This could include movement beyond a certain threshold, force changes, sensor readings, or any predefined event. Some embodiments additionally or alternatively determine the start and end points of the delta layer. For example, a delta layer is defined to capture all changes within a specific event or time interval. In some embodiments, each delta layer is timestamped and sequenced to ensure proper chronological order when applied to the base layer. In an illustrative example, a function compares the new sensor data with the current state in the base layer. The function identifies significant changes in joint positions and sensor data over a threshold. If changes are detected over this threshold, the function creates a delta layer containing the new data and a timestamp. If a delta layer is created, it is saved to a file.

In some embodiments, after the layers 302-2 are constructed, the digital twin 302-1 is then created or generated. Various embodiments use geometric data in the layers 302-2 to create a 3D model of the robot 304 and its environment. Various embodiments additionally integrate state data (e.g., joint angles, positions) within the layers 302-2 to reflect the current configuration of the robot 304. Various embodiments also include data about the environment, such as obstacles, objects, and their states. Specifically, delta layers are used to continuously update the digital twin 302-1 with real-time data from the robot 304's sensors and actions, ensuring that the digital twin 302-1 remains an accurate reflection of the physical world. Various embodiments start with the base layer to get the initial state of the digital twin 302-1. Then particular embodiments sequentially apply delta layers to the base layer to update the state of the digital twin 302-1 with the latest data. In other words, the digital twin 302-1 is initially created using the base layer in 302-2, which captures the complete initial state of the robot 304 and its environment. As the robot 304 performs tasks and new data is collected, delta layers in 302-2 are created to capture these changes. The digital twin 302-1 is updated by applying these delta layers to the base layer. This process forms a continuous loop where the digital twin 302-1 is kept up-to-date by sequentially applying new delta layers to the base layer.

To create the digital twin 302-1, various embodiments create detailed 3D models of the robot 304 and environment. The simulation parameters define physical properties, kinematics, and dynamics for accurate simulation. There are also real-time updates to continuously update the digital twin 302-2 with real-time data from the robot's sensors. Various embodiments also use visualization tools to display the digital twin 302-2 and its state.

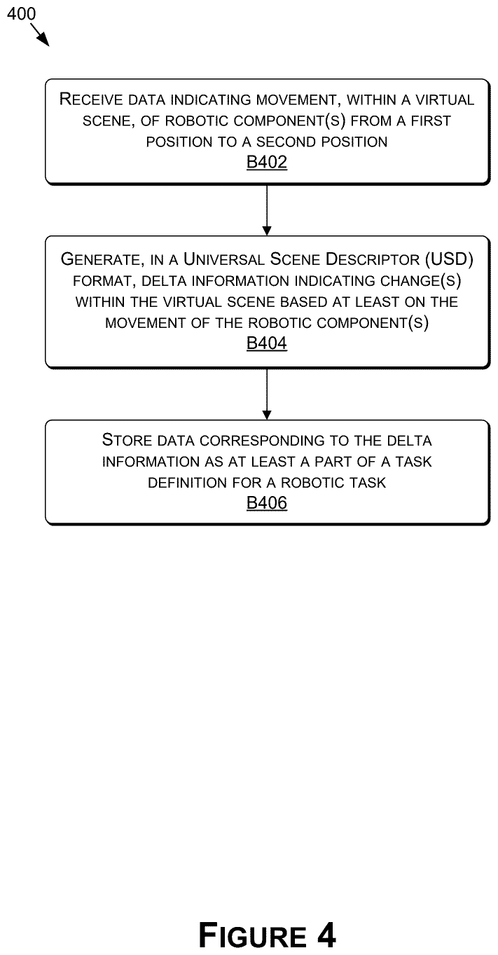

Now referring to FIGS. 4, 5, and 6 each block of processes 400, 500, and 600 described herein, comprises a computing process that may be performed using any combination of hardware, firmware, and/or software. For instance, various functions may be carried out by a processor executing instructions stored in memory, dedicated AI hardware accelerator circuitry, or the like. The processes may also be embodied as computer-usable instructions stored on computer storage media. The methods may be provided by a standalone application, a service or hosted service (standalone or in combination with another hosted service), or a plug-in to another product, to name a few. In addition, the processes 400, 500, and/or 600 are described, by way of example, with respect to the pipeline 100 of FIG. 1. However, these processes may additionally or alternatively be executed by any one system, or any combination of systems, including, but not limited to, those described herein.

FIG. 4 is a flow diagram of an example method for using delta information to define a task definition for one or more robotic components, according to some embodiments. Per block 402, some embodiments (e.g., the delta layer generator 106) receive data indicating movement, within a virtual scene (e.g., the scene data 104 of FIG. 1), of one or more robotic components from a first position to a second position. The “one or more robotic components” refer to any robot, either virtual or real-world, and/or its components, such as a robotic arm, robotic leg, robotic phalanges, and/or the like. Examples of such data and/or virtual scene described in block 402 is any portion of the OpenUSD file(s) 302 of FIG. 3 and/or the scene data 104 of FIG. 1.

Per block 404, some embodiments (e.g., the delta layer generator 106) generate, in a Universal Scene Descriptor (USD) format, delta information indicating one or more changes within the virtual scene based at least on the movement of the one or more robotic components. USD is a software framework and a file format designed for the interchange and collaborative editing of 3D graphics data. An example of USD is OpenUSD, as described herein. “Delta information” as described herein refers to any data structure and/or data (e.g., functions, routines, etc.) that at least include an indication of the one or more changes. For example, delta information can include a root layer, base layer, and/or a delta layer. In another example, delta information refers directly to a delta layer, which contains only an indication of the one or more changes within the virtual scene and excludes any indication of the virtual scene that has not been changed. An example of a delta layer is described in the coding structure of the screenshot 200-3 of FIG. 2D.

In some embodiments, the “movement of the robotic component(s)” refers to actual real-world movement of the robotic component(s). In alternative or additional embodiments, this refers to virtual movement of a virtual representation of the robotic component(s). In other words, the delta information, for example, can represent the first delta layer(s) 108 and/or the second delta layer(s) 112.

In some embodiments, the generating of the delta information at block 404 is based on a natural language request issued by a user and processed by a language model For example, the delta layer generator 106 generates multiple delta layers in response to a user issuing a natural language utterance, “generate a digital twin of a robot picking up a ball and placing it on a table.” Such phrase is then tokenized (e.g., parsed into sub-characters, such as words) and then fed as input into a language model (e.g., a Large Language Model, a diffusion model, etc.), which then generates a text description (e.g., via text summarization) and/or a visual representation (e.g., a digital twin) of a base layer and/or all of the delta layers (e.g., via the use of a CLIP model). In some embodiments, the generation of the delta information at block 404 is additionally or alternatively based on computer user input at a user interface. For example, as described with respect to FIG. 2C, particular embodiments receive an indication that the user has selected the mute layer 210 and responsively cause a change in presentation of the sphere 202 relative to its position in FIG. 2A, as described above. Alternatively or additionally, particular embodiments receive an indication that the user has dragged the sphere 202 to its current location indicated in FIG. 2C from its original position in FIG. 2A, and responsively generate the delta layers and visual representations of such movement.

In some embodiments, the generation of the delta information at bock 404 is based on a user request that defines a quantity of delta layers to be generated between an initial state and a final state of the virtual scene. The concept of generating delta layers based on a user request involves creating multiple intermediate states between an initial state and a final state of a virtual scene. This approach allows for finer control and granularity in the transitions and actions performed by the robot, enabling more precise and incremental updates to a digital twin, for example. In an illustrative example, a user first defines the initial state: robot position: (0, 0, 0), object position: (5, 0, 0), and final state: robot position: (10, 0, 0), and object state: picked up by the robot. Various embodiments then receive a user request to generate the number of delta layers, such as 5. Various embodiments then calculate the intermediate states and generate the delta layers according to the user request (e.g., Delta Layer 1: {“robot_position”: [2, 0, 0]} Delta Layer 2: {“robot_position”: [4, 0, 0]} Delta Layer 3: {“robot_position”: [6, 0, 0], “object_state”: “picked”} Delta Layer 4: {“robot_position”: [8, 0, 0]} Delta Layer 5: {“robot_position”: [10, 0, 0], “object_position”: [10, 0, 0]}).

Continuing with FIG. 4, per block 406 some embodiments store data corresponding to the delta information as at least a part of a task definition for a robotic task. This involves capturing the incremental changes represented by the delta layer and associating these changes with a specific task that the robot needs to perform. This process can be programmatically implemented using a combination of data structures, file storage, and/or task management systems.

The delta layer data, for example, includes the incremental changes or updates captured in the delta layer, including changes in positions, states, forces, sensor data, etc. The task definition is the description of the task that the robot needs to perform, which includes the sequence of delta layers to be applied. A system for storing the task definitions and associated delta layers, which can be implemented using files, databases, or other storage mechanisms. For example, some embodiments first collect the data representing the incremental changes or updates for the delta layer. Some embodiments then define a task that the robot needs to perform and associate the delta layer with this task. For example, some embodiments generate a lookup or other data structure that maps a delta layer with a task definition or vice versa. Some embodiments then save the task definition and delta layer data in a storage system, ensuring they are linked for easy retrieval and execution by the robot. In an illustrative example, a dictionary can be used to map task IDs to their corresponding delta layers and steps. In another example, a database table can be used to store task definitions and their associated delta layers.

In some embodiments, based on the delta information and the task definition at blocks 404 and 406, some embodiments cause the one or more robotic components to perform a task in a scene represented by the virtual scene. Examples of this are described in FIG. 3, where, for example, the robot 304 takes, as input, the OpenUSD file 302 (which includes the delta layers) to perform the real-world action of picking or placing the package 306 to or from the location 308.

In some embodiments, the method 400 further includes the following operations. Some embodiments generate, in the USD data format, second delta information (e.g., the second delta layer(s) 112) indicating a change in movement based at least on the one or more robotic components performing a task in a scene represented by the virtual scene. Some embodiments then measure, by comparing the delta information with the second delta information, the task's adherence to the task definition. Examples of this functionality are described with respect to the robotic task executor 110, the delta layer generator 106 generating the second delta layer(s) 112, and the robotic task adherence component 114 of FIG. 1.

In some embodiments, the virtual scene and the delta information of blocks 402 and 404 are included in a file (e.g., the OPenUSD file(s) 302 of FIG. 3). And in some embodiments the virtual scene represents a digital twin (e.g., the digital twin 302-1 of FIG. 3) of a virtual robot that executes a virtual task in a virtual environment. Some embodiments then provide the one or more robotic components (e.g., the robot 304) the file as input such that the one or more robotic components execute a real-world task in an environment represented by the virtual environment based on using the file as input. Examples of this are described with respect to FIG. 3.

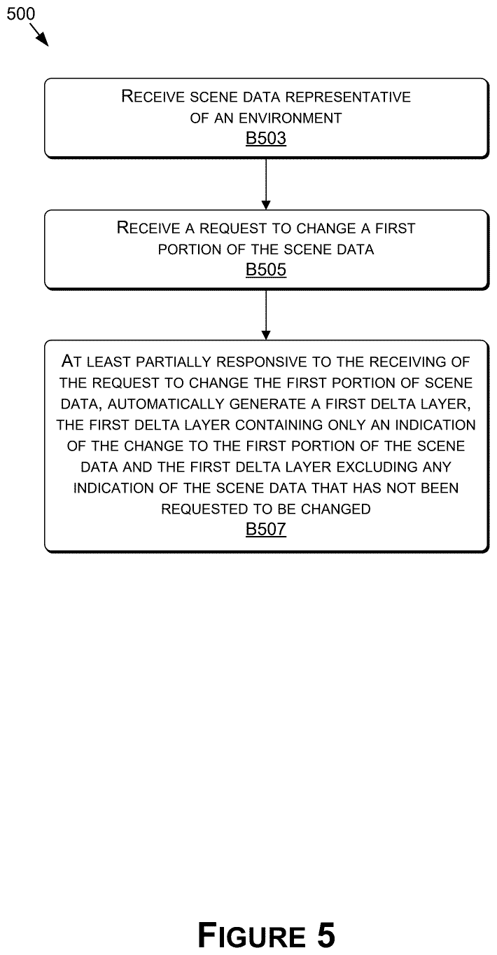

FIG. 5 is a flow diagram of an example method 500 for generating a delta layer, according to some embodiments. In some embodiments, the process 500 includes some or all of the functionality as described in the method 400 of FIG. 4. Per block 503, some embodiments receive scene data representative of an environment. “Scene data” can refer to visualizations of a scene, such as the sphere 202 and ground 204 of FIG. 2A and/or the coding structure responsible for such visualizations, such as the coding structure illustrated in the page 2000-1 of FIG. 2. In an illustrative example of block 503, as described with respect to FIG. 1, the delta layer generator 106 receives the scene data 104. In some embodiments, the scene data and the first delta layer at block 507 are a part of a 3D content collaboration platform for 3D assets that uses OpenUSD, as described herein.

In some embodiments, the scene data and the first delta layer are included in at least one of, a robotics application, a graphics rendering application, a gaming application, or an autonomous driving application. For example, with respect to a graphics rendering application, delta layers can manage changes in complex 3D scenes, enabling non-destructive edits and efficient updates. Artists can use delta layers to experiment with different scene versions, comparing changes without altering the original scene. For example, in a CGI film, different aspects of a scene (like lighting, textures, and models) are managed using delta layers. This allows artists to tweak individual elements, render previews, and revert to previous states seamlessly, enhancing creativity and workflow efficiency.

With respect to a gaming application, delta layers can manage incremental changes in game levels, character states, and environmental interactions. Games can use delta layers to implement dynamic content updates, player-driven changes, and real-time world modifications. For example, in an open-world game, the base layer defines the initial game world. Delta layers capture player interactions, quest progress, and environmental changes. This allows for a responsive and evolving game world, enhancing player immersion and experience.

With respect to an autonomous driving application, delta layers can manage real-time updates to the autonomous vehicle's environment map, reflecting changes in traffic, obstacles, and road conditions. Ego machines (e.g., autonomous cars) can use delta layers to update their decision-making processes, adapting to new data from sensors and external sources. For example, autonomous cars use a base layer to define the initial state of the driving environment. Delta layers capture real-time changes like traffic updates, pedestrian movements, and weather conditions. The vehicle's control system uses these updates to navigate safely and efficiently, adapting to dynamic road conditions.

Similarly, in some embodiments, the scene data being generated using at least one of: one or more light transport algorithms, a three-dimensional (3D) content collaboration platform, simulated sensor data of simulated sensors of a virtual or simulated machine, or a platform to create one or more tasks for one or more robots. Examples of this are described with respect to the generation of the scene data 104 of FIG. 1.

In some embodiments, the change (or requested change) to the first portion of the scene data at block 404 includes at least one of, a change in position of one or more objects in the first portion of the scene data, a change in velocity of the one or more objects in the first portion, a change in acceleration of the one or more objects in the first portion, a change in color of the one or more objects, a change in shape of the one or more objects, or a change in reflectivity of the one or more objects.

Continuing with the method 500 of FIG. 5, per block 507, at least partially responsive to the receiving of the request to change the first portion of the scene data (or an actual change of the first portion), some embodiments automatically generate a first delta layer. The first delta layer contains only an indication (e.g., a data structure or “over” element) of the change to the first portion of the scene data. The first delta layer excludes any indication of the scene data that has not been requested to be changed. Examples of block 507 are illustrated in FIG. 2D, where the first delta layer includes only program statements and data structures indicating only the change in position of the sphere 202 and not any other information in the scene data, such as the ground 204.

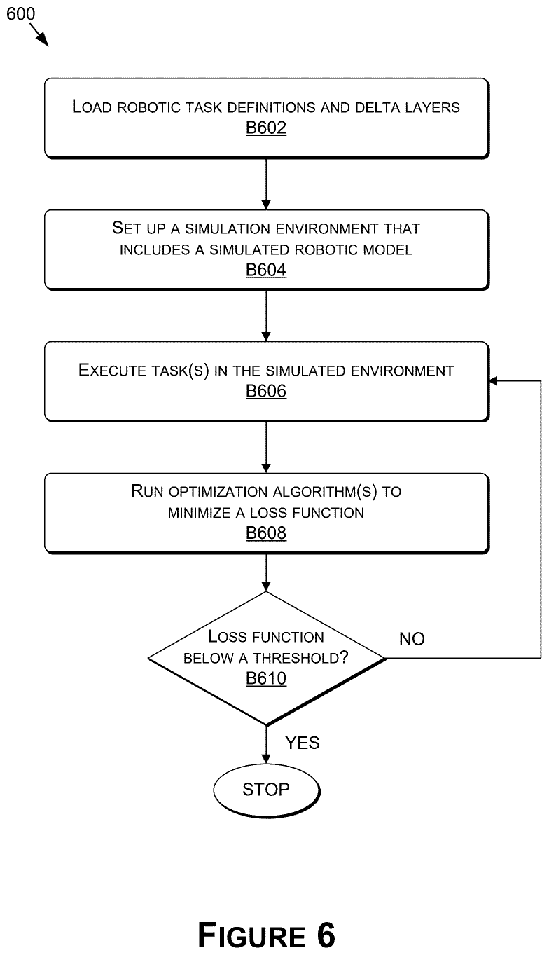

FIG. 6 is a flow diagram of an example method 600 for training one or more virtual robots in a simulation, according to some embodiments. Per block 602, some embodiments first load robotic task definitions and delta layers. In some instances, this includes loading a base layer indicative of loading the initial state of a virtual scene from the base layer. Various embodiments then load a sequence of delta layers that represent the incremental changes and movements required to perform the task. Some embodiments apply the delta layers to the base layer to reconstruct the task sequence. In some embodiments, the delta layers are annotated or labeled with desired positions, states, and expected outcomes to guide the training process, such as the virtual robot's initial state, sensor readings, control commands, the robot's resulting state, positions, and/or performance metrics.

Per block 604, some embodiments then set up a simulation environment that includes a simulated robotic model (i.e., a virtual robot). This includes initializing simulation, which includes setting up the simulation environment to mimic the virtual scene defined (e.g., in the USD files). Some embodiments then load the simulated robot model, ensuring it matches a physical robot's specifications. For example, some embodiments define physical specifications of the physical robot and record it in the simulated environment, such as geometry (e.g., the shape, size, and structure of the robot), kinematics (e.g., the movement capabilities, including joint types (e.g., revolute, prismatic) and their ranges of motion), dynamics (e.g., the physical properties like mass, inertia, and forces), sensors (e.g., types and placements of sensors (e.g., cameras, LiDAR, force sensors), actuators (e.g., motors and actuators, including their capabilities and limitations). Some embodiments use a simulation software or environment (e.g., Gazebo, ROS, Unity, or custom simulators) to create or load the robot model. Various embodiments then apply the initial conditions from the base layer to the virtual robot and environment in the simulation.

Per block 606, some embodiments then execute one or more tasks (e.g., defined by the task definition) in the simulated environment. Specifically, some embodiments sequentially apply each delta layer to the virtual robot and environment in the simulation. Various embodiments command the virtual robot to move and perform actions based on the changes indicated in each delta layer. Some embodiments continuously monitor the virtual robot's actions, recording its state, sensor data, and performance metrics.

Per block 608, some embodiments then run one or more optimization algorithms (e.g., gradient descent, reinforcement learning) to minimize a loss function. The one or more optimization algorithms aim to minimize the difference between the desired task outcomes (as defined by the delta layers) and the actual outcomes achieved by the virtual robot. For example, some embodiments minimize the distance between the virtual robot's final position and the target position (as indicated in a delta layer), and ensure the correct state of manipulated objects. For instance, gradients are computed based on the difference between the actual and desired states, guiding how the parameters should be updated. In some embodiments, such as in Gradient Descent, the optimization algorithm(s) update the parameters in the direction opposite to the gradients to minimize the loss function. The loss function quantifies the error or deviation from the desired task outcomes. For example, a loss function is represented as follows in some embodiments:

$$L = {w}_{1} * ‖ {P}_{des ired} - {P}_{actual} ‖ + {w}_{2} * ‖ {S}_{desired} - {S}_{actual} ‖$$

where P_{desired} and P_{actual} are the desired and actual positions, S_{desired} and S_{actual} are the desired and actual states of objects, and w₁ and w₂ are weights balancing the position and state errors.

Per block 610, it is determined whether the loss indicated in the loss function is below a threshold. If the decision is “no” at block 610, the blocks 606, 608, and 610 are repeated, representing different epochs or iterations in training. In other words, the robot model/virtual robot is updated iteratively until the loss function is minimized below a specified threshold. This process ensures that the virtual robot's performance improves progressively, with the goal of achieving the desired outcomes as closely as possible. After each iteration, various embodiments check if the loss function is below the specified threshold at block 610. If the loss is below the threshold, the training process 600 stops, indicating that the robot has learned to perform the task satisfactorily. The process continues until the loss function is minimized below the threshold or the maximum number of iterations is reached.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets, systems implemented at least partially using cloud computing resources, and/or other types of systems.

### Example Autonomous Vehicle

FIG. 7A is an illustration of an example autonomous vehicle 700, in accordance with some embodiments of the present disclosure. The autonomous vehicle 700 (alternatively referred to herein as the “vehicle 700”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 700 may be capable of functionality in accordance with one or more of Level 3-Level 5 of the autonomous driving levels. The vehicle 700 may be capable of functionality in accordance with one or more of Level 1-Level 5 of the autonomous driving levels. For example, the vehicle 700 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 700 or other machine, such as being fully autonomous, being highly autonomous, being conditionally autonomous, being partially autonomous, providing assistive autonomy, being semi-autonomous, being primarily autonomous, or other designation.

The vehicle 700 may include components such as a chassis, a vehicle body, wheels (e.g., 2, 4, 6, 8, 18, etc.), tires, axles, and other components of a vehicle. The vehicle 700 may include a propulsion system 750, such as an internal combustion engine, hybrid electric power plant, an all-electric engine, and/or another propulsion system type. The propulsion system 750 may be connected to a drive train of the vehicle 700, which may include a transmission, to allow the propulsion of the vehicle 700. The propulsion system 750 may be controlled in response to receiving signals from the throttle/accelerator 752.

A steering system 754, which may include a steering wheel, may be used to steer the vehicle 700 (e.g., along a desired path or route) when the propulsion system 750 is operating (e.g., when the vehicle is in motion). The steering system 754 may receive signals from a steering actuator 756. The steering wheel may be optional for full automation (Level 5) functionality.

The brake sensor system 746 may be used to operate the vehicle brakes in response to receiving signals from the brake actuators 748 and/or brake sensors.

Controller(s) 736, which may include one or more system on chips (SoCs) 704 (FIG. 7C) and/or GPU(s), may provide signals (e.g., representative of commands) to one or more components and/or systems of the vehicle 700. For example, the controller(s) may send signals to operate the vehicle brakes via one or more brake actuators 748, to operate the steering system 754 via one or more steering actuators 756, to operate the propulsion system 750 via one or more throttle/accelerators 752. The controller(s) 736 may include one or more onboard (e.g., integrated) computing devices (e.g., supercomputers) that process sensor signals, and output operation commands (e.g., signals representing commands) to allow autonomous driving and/or to assist a human driver in driving the vehicle 700. The controller(s) 736 may include a first controller 736 for autonomous driving functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. In some examples, a single controller 736 may handle two or more of the above functionalities, two or more controllers 736 may handle a single functionality, and/or any combination thereof.

The controller(s) 736 may provide the signals for controlling one or more components and/or systems of the vehicle 700 in response to sensor data received from one or more sensors (e.g., sensor inputs). The sensor data may be received from, for example and without limitation, global navigation satellite systems (“GNSS”) sensor(s) 758 (e.g., Global Positioning System sensor(s)), RADAR sensor(s) 760, ultrasonic sensor(s) 762, LiDAR sensor(s) 764, inertial measurement unit (IMU) sensor(s) 766 (e.g., accelerometer(s), gyroscope(s), magnetic compass(es), magnetometer(s), etc.), microphone(s) 796, stereo camera(s) 768, wide-view camera(s) 770 (e.g., fisheye cameras), infrared camera(s) 772, surround camera(s) 774 (e.g., 360 degree cameras), long-range and/or mid-range camera(s) 798, speed sensor(s) 744 (e.g., for measuring the speed of the vehicle 700), vibration sensor(s) 742, steering sensor(s) 740, brake sensor(s) (e.g., as part of the brake sensor system 746), one or more occupant monitoring system (OMS) sensor(s) 701 (e.g., one or more interior cameras), and/or other sensor types.

One or more of the controller(s) 736 may receive inputs (e.g., represented by input data) from an instrument cluster 732 of the vehicle 700 and provide outputs (e.g., represented by output data, display data, etc.) via a human-machine interface (HMI) display 734, an audible annunciator, a loudspeaker, and/or via other components of the vehicle 700. The outputs may include information such as vehicle velocity, speed, time, map data (e.g., the High Definition (“HD”) map 722 of FIG. 7C), location data (e.g., the vehicle's 700 location, such as on a map), direction, location of other vehicles (e.g., an occupancy grid), information about objects and status of objects as perceived by the controller(s) 736, etc. For example, the HMI display 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 700 further includes a network interface 724 which may use one or more wireless antenna(s) 726 and/or modem(s) to communicate over one or more networks. For example, the network interface 724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 726 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 7B is an example of camera locations and fields of view for the example autonomous vehicle 700 of FIG. 7A, in accordance with some embodiments of the present disclosure. The cameras and respective fields of view are one example embodiment and are not intended to be limiting. For example, additional and/or alternative cameras may be included and/or the cameras may be located at different locations on the vehicle 700.

The camera types for the cameras may include, but are not limited to, digital cameras that may be adapted for use with the components and/or systems of the vehicle 700. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 770 that may be used to perceive objects coming into view from the periphery (e.g., pedestrians, crossing traffic or bicycles). Although only one wide-view camera is illustrated in FIG. 7B, there may be any number (including zero) of wide-view cameras 770 on the vehicle 700. In addition, any number of long-range camera(s) 798 (e.g., a long-view stereo camera pair) may be used for depth-based object detection, especially for objects for which a neural network has not yet been trained. The long-range camera(s) 798 may also be used for object detection and classification, as well as basic object tracking.

Any number of stereo cameras 768 may also be included in a front-facing configuration. In at least one embodiment, one or more of stereo camera(s) 768 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 768 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768 may be used in addition to, or alternatively from, those described herein.

Cameras with a field of view that include portions of the environment to the side of the vehicle 700 (e.g., side-view cameras) may be used for surround view, providing information used to create and update the occupancy grid, as well as to generate side impact collision warnings. For example, surround camera(s) 774 (e.g., four surround cameras 774 as illustrated in FIG. 7B) may be positioned to on the vehicle 700. The surround camera(s) 774 may include wide-view camera(s) 770, fisheye camera(s), 360 degree camera(s), and/or the like. Four example, four fisheye cameras may be positioned on the vehicle's front, rear, and sides. In an alternative arrangement, the vehicle may use three surround camera(s) 774 (e.g., left, right, and rear), and may leverage one or more other camera(s) (e.g., a forward-facing camera) as a fourth surround view camera.

Cameras with a field of view that include portions of the environment to the rear of the vehicle 700 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 798, stereo camera(s) 768), infrared camera(s) 772, etc.), as described herein.

Cameras with a field of view that include portions of the interior environment within the cabin of the vehicle 700 (e.g., one or more OMS sensor(s) 701) may be used as part of an occupant monitoring system (OMS) such as, but not limited to, a driver monitoring system (DMS). For example, OMS sensors (e.g., the OMS sensor(s) 701) may be used (e.g., by the controller(s) 736) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 7C is a block diagram of an example system architecture for the example autonomous vehicle 700 of FIG. 7A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 700 in FIG. 7C are illustrated as being connected via bus 702. The bus 702 may include a Controller Area Network (CAN) data interface (alternatively referred to herein as a “CAN bus”). A CAN may be a network inside the vehicle 700 used to aid in control of various features and functionality of the vehicle 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 702 is described herein as being a CAN bus, this is not intended to be limiting. For example, in addition to, or alternatively from, the CAN bus, FlexRay and/or Ethernet may be used. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the vehicle 700, and two or more busses 702 may communicate with the same components. In some examples, each SoC 704, each controller 736, and/or each computer within the vehicle may have access to the same input data (e.g., inputs from sensors of the vehicle 700), and may be connected to a common bus, such the CAN bus.

The vehicle 700 may include one or more controller(s) 736, such as those described herein with respect to FIG. 7A. The controller(s) 736 may be used for a variety of functions. The controller(s) 736 may be coupled to any of the various other components and systems of the vehicle 700, and may be used for control of the vehicle 700, artificial intelligence of the vehicle 700, infotainment for the vehicle 700, and/or the like.

The vehicle 700 may include a system(s) on a chip (SoC) 704. The SoC 704 may include CPU(s) 706, GPU(s) 708, processor(s) 710, cache(s) 712, accelerator(s) 714, data store(s) 716, and/or other components and features not illustrated. The SoC(s) 704 may be used to control the vehicle 700 in a variety of platforms and systems. For example, the SoC(s) 704 may be combined in a system (e.g., the system of the vehicle 700) with an HD map 722 which may obtain map refreshes and/or updates via a network interface 724 from one or more servers (e.g., server(s) 778 of FIG. 7D).

The CPU(s) 706 may include a CPU cluster or CPU complex (alternatively referred to herein as a “CCPLEX”). The CPU(s) 706 may include multiple cores and/or L2 caches. For example, in some embodiments, the CPU(s) 706 may include eight cores in a coherent multi-processor configuration. In some embodiments, the CPU(s) 706 may include four dual-core clusters where each cluster has a dedicated L2 cache (e.g., a 2 MB L2 cache). The CPU(s) 706 (e.g., the CCPLEX) may be configured to support simultaneous cluster operation allowing any combination of the clusters of the CPU(s) 706 to be active at any given time.

The CPU(s) 706 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 706 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 708 may include an integrated GPU (alternatively referred to herein as an “iGPU”). The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA's CUDA).

The GPU(s) 708 may be power-optimized for best performance in automotive and embedded use cases. For example, the GPU(s) 708 may be fabricated on a Fin field-effect transistor (FinFET). However, this is not intended to be limiting and the GPU(s) 708 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 708 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

In addition, the GPU(s) 708 may include an access counter that may keep track of the frequency of access of the GPU(s) 708 to memory of other processors. The access counter may help ensure that memory pages are moved to the physical memory of the processor that is accessing the pages most frequently.

The SoC(s) 704 may include any number of cache(s) 712, including those described herein. For example, the cache(s) 712 may include an L3 cache that is available to both the CPU(s) 706 and the GPU(s) 708 (e.g., that is connected both the CPU(s) 706 and the GPU(s) 708). The cache(s) 712 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 704 may include an arithmetic logic unit(s) (ALU(s)) which may be leveraged in performing processing with respect to any of the variety of tasks or operations of the vehicle 700—such as processing DNNs. In addition, the SoC(s) 704 may include a floating point unit(s) (FPU(s))—or other math coprocessor or numeric coprocessor types—for performing mathematical operations within the system. For example, the SoC(s) 704 may include one or more FPUs integrated as execution units within a CPU(s) 706 and/or GPU(s) 708.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 714 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 708, and by using an inference accelerator, for example, a designer may target either the DLA(s) or the GPU(s) 708 for any function. For example, the designer may focus processing of CNNs and floating point operations on the DLA(s) and leave other functions to the GPU(s) 708 and/or other accelerator(s) 714.

The accelerator(s) 714 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 706. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 714 (e.g., the hardware acceleration cluster) may include a computer vision network on-chip and SRAM, for providing a high-bandwidth, low latency SRAM for the accelerator(s) 714. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 704 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 714 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 766 output that correlates with the vehicle 700 orientation, distance, 3D location estimates of the object obtained from the neural network and/or other sensors (e.g., LiDAR sensor(s) 764 or RADAR sensor(s) 760), among others.

The SoC(s) 704 may include data store(s) 716 (e.g., memory). The data store(s) 716 may be on-chip memory of the SoC(s) 704, which may store neural networks to be executed on the GPU and/or the DLA. In some examples, the data store(s) 716 may be large enough in capacity to store multiple instances of neural networks for redundancy and safety. The data store(s) 716 may comprise L2 or L3 cache(s) 712. Reference to the data store(s) 716 may include reference to the memory associated with the PVA, DLA, and/or other accelerator(s) 714, as described herein.

The SoC(s) 704 may include one or more processor(s) 710 (e.g., embedded processors). The processor(s) 710 may include a boot and power management processor that may be a dedicated processor and subsystem to handle boot power and management functions and related security enforcement. The boot and power management processor may be a part of the SoC(s) 704 boot sequence and may provide runtime power management services. The boot power and management processor may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, and/or accelerator(s) 714. If temperatures are determined to exceed a threshold, the boot and power management processor may enter a temperature fault routine and put the SoC(s) 704 into a lower power state and/or put the vehicle 700 into a chauffeur to safe stop mode (e.g., bring the vehicle 700 to a safe stop).

The processor(s) 710 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 710 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 710 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 710 may further include a real-time camera engine that may include a dedicated processor subsystem for handling real-time camera management.

The processor(s) 710 may further include a high-dynamic range signal processor that may include an image signal processor that is a hardware engine that is part of the camera processing pipeline.

The processor(s) 710 may include a video image compositor that may be a processing block (e.g., implemented on a microprocessor) that implements video post-processing functions needed by a video playback application to produce the final image for the player window. The video image compositor may perform lens distortion correction on wide-view camera(s) 770, surround camera(s) 774, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a mobile industry processor interface (MIPI) camera serial interface for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role.

The SoC(s) 704 may further include a broad range of peripheral interfaces to allow communication with peripherals, audio codecs, power management, and/or other devices. The SoC(s) 704 may be used to process data from cameras (e.g., connected over Gigabit Multimedia Serial Link and Ethernet), sensors (e.g., LiDAR sensor(s) 764, RADAR sensor(s) 760, etc. that may be connected over Ethernet), data from bus 702 (e.g., speed of vehicle 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks.

The SoC(s) 704 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example.

In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 720) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 708.

In some examples, a CNN for facial recognition and vehicle owner identification may use data from camera sensors to identify the presence of an authorized driver and/or owner of the vehicle 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In another example, a CNN for emergency vehicle detection and identification may use data from microphones 796 to detect and identify emergency vehicle sirens. In contrast to conventional systems, that use general classifiers to detect sirens and manually extract features, the SoC(s) 704 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 758. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 762, until the emergency vehicle(s) passes.

The vehicle may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The vehicle 700 may include a GPU(s) 720 (e.g., discrete GPU(s), or dGPU(s)), that may be coupled to the SoC(s) 704 via a high-speed interconnect (e.g., NVIDIA's NVLINK). The GPU(s) 720 may provide additional artificial intelligence functionality, such as by executing redundant and/or different neural networks, and may be used to train and/or update neural networks based on input (e.g., sensor data) from sensors of the vehicle 700.

The vehicle 700 may further include the network interface 724 which may include one or more wireless antennas 726 (e.g., one or more wireless antennas for different communication protocols, such as a cellular antenna, a Bluetooth antenna, etc.). The network interface 724 may be used to allow wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 700 information about vehicles in proximity to the vehicle 700 (e.g., vehicles in front of, on the side of, and/or behind the vehicle 700). This functionality may be part of a cooperative adaptive cruise control functionality of the vehicle 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The vehicle 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The vehicle 700 may further include RADAR sensor(s) 760. The RADAR sensor(s) 760 may be used by the vehicle 700 for long-range vehicle detection, even in darkness and/or severe weather conditions. RADAR functional safety levels may be ASIL B. The RADAR sensor(s) 760 may use the CAN and/or the bus 702 (e.g., to transmit data generated using the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250m range. The RADAR sensor(s) 760 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 700 surroundings at higher speeds with minimal interference from traffic in adjacent lanes. The other two antennae may expand the field of view, making it possible to quickly detect vehicles entering or leaving the vehicle's 700 lane.

Mid-range RADAR systems may include, as an example, a range of up to 760m (front) or 80m (rear), and a field of view of up to 42 degrees (front) or 750 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 700 may further include ultrasonic sensor(s) 762. The ultrasonic sensor(s) 762, which may be positioned at the front, back, and/or the sides of the vehicle 700, may be used for park assist and/or to create and update an occupancy grid. A wide variety of ultrasonic sensor(s) 762 may be used, and different ultrasonic sensor(s) 762 may be used for different ranges of detection (e.g., 2.5m, 4m). The ultrasonic sensor(s) 762 may operate at functional safety levels of ASIL B.

The vehicle 700 may include LiDAR sensor(s) 764. The LiDAR sensor(s) 764 may be used for object and pedestrian detection, emergency braking, collision avoidance, and/or other functions. The LiDAR sensor(s) 764 may be functional safety level ASIL B. In some examples, the vehicle 700 may include multiple LiDAR sensors 764 (e.g., two, four, six, etc.) that may use Ethernet (e.g., to provide data to a Gigabit Ethernet switch).

In some examples, the LiDAR sensor(s) 764 may be capable of providing a list of objects and their distances for a 360-degree field of view. Commercially available LiDAR sensor(s) 764 may have an advertised range of approximately 700m, with an accuracy of 2 cm-3 cm, and with support for a 700 Mbps Ethernet connection, for example. In some examples, one or more non-protruding LiDAR sensors 764 may be used. In such examples, the LiDAR sensor(s) 764 may be implemented as a small device that may be embedded into the front, rear, sides, and/or corners of the vehicle 700. The LiDAR sensor(s) 764, in such examples, may provide up to a 120-degree horizontal and 35-degree vertical field-of-view, with a 200m range even for low-reflectivity objects. Front-mounted LiDAR sensor(s) 764 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 700. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 764 may be less susceptible to motion blur, vibration, and/or shock.

The vehicle may further include IMU sensor(s) 766. The IMU sensor(s) 766 may be located at a center of the rear axle of the vehicle 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some embodiments, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may allow the vehicle 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include microphone(s) 796 placed in and/or around the vehicle 700. The microphone(s) 796 may be used for emergency vehicle detection and identification, among other things.

The vehicle may further include any number of camera types, including stereo camera(s) 768, wide-view camera(s) 770, infrared camera(s) 772, surround camera(s) 774, long-range and/or mid-range camera(s) 798, and/or other camera types. The cameras may be used to capture image data around an entire periphery of the vehicle 700. The types of cameras used depends on the embodiments and requirements for the vehicle 700, and any combination of camera types may be used to provide the necessary coverage around the vehicle 700. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 7A and FIG. 7B.

The vehicle 700 may further include vibration sensor(s) 742. The vibration sensor(s) 742 may measure vibrations of components of the vehicle, such as the axle(s). For example, changes in vibrations may indicate a change in road surfaces. In another example, when two or more vibration sensors 742 are used, the differences between the vibrations may be used to determine friction or slippage of the road surface (e.g., when the difference in vibration is between a power-driven axle and a freely rotating axle).

The vehicle 700 may include an ADAS system 738. The ADAS system 738 may include SoC, in some examples. The ADAS system 738 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 760, LiDAR sensor(s) 764, and/or a camera(s). The ACC systems may include longitudinal ACC and/or lateral ACC. Longitudinal ACC monitors and controls the distance to the vehicle immediately ahead of the vehicle 700 and automatically adjust the vehicle speed to maintain a safe distance from vehicles ahead. Lateral ACC performs distance keeping, and advises the vehicle 700 to change lanes when necessary. Lateral ACC is related to other ADAS applications such as LCA and CWS.

CACC uses information from other vehicles that may be received via the network interface 724 and/or the wireless antenna(s) 726 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 700), while the 12V communication concept provides information about traffic further ahead. CACC systems may include either or both I2V and V2V information sources. Given the information of the vehicles ahead of the vehicle 700, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 760, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 760, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 700 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 700 if the vehicle 700 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 760, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 700 is backing up. Some RCTW systems include AEB to ensure that the vehicle brakes are applied to avoid a crash. RCTW systems may use one or more rear-facing RADAR sensor(s) 760, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 700, the vehicle 700 itself must, in the case of conflicting results, decide whether to heed the result from a primary computer or a secondary computer (e.g., a first controller 736 or a second controller 736). For example, in some embodiments, the ADAS system 738 may be a backup and/or secondary computer for providing perception information to a backup computer rationality module. The backup computer rationality monitor may run a redundant diverse software on hardware components to detect faults in perception and dynamic driving tasks. Outputs from the ADAS system 738 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 704.

In other examples, ADAS system 738 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 738 may be fed into the primary computer's perception block and/or the primary computer's dynamic driving task block. For example, if the ADAS system 738 indicates a forward crash warning due to an object immediately ahead, the perception block may use this information when identifying objects. In other examples, the secondary computer may have its own neural network which is trained and thus reduces the risk of false positives, as described herein.

The vehicle 700 may further include the infotainment SoC 730 (e.g., an in-vehicle infotainment system (IVI)). Although illustrated and described as a SoC, the infotainment system may not be a SoC, and may include two or more discrete components. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the vehicle 700. In some examples, the infotainment SoC 730 may be coupled to a supervisory MCU such that the GPU of the infotainment system may perform some self-driving functions in the event that the primary controller(s) 736 (e.g., the primary and/or backup computers of the vehicle 700) fail. In such an example, the infotainment SoC 730 may put the vehicle 700 into a chauffeur to safe stop mode, as described herein.

The vehicle 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. As such, the instrument cluster 732 may be included as part of the infotainment SoC 730, or vice versa.

FIG. 7D is a system diagram for communication between cloud-based server(s) and the example autonomous vehicle 700 of FIG. 7A, in accordance with some embodiments of the present disclosure. The system 776 may include server(s) 778, network(s) 790, and vehicles, including the vehicle 700. The server(s) 778 may include a plurality of GPUs 784(A)-784(H) (collectively referred to herein as GPUs 784), PCIe switches 782(A)-782(D) (collectively referred to herein as PCIe switches 782), and/or CPUs 780(A)-780(B) (collectively referred to herein as CPUs 780). The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the vehicles, image data representative of images showing unexpected or changed road conditions, such as recently commenced road-work. The server(s) 778 may transmit, over the network(s) 790 and to the vehicles, neural networks 792, updated neural networks 792, and/or map information 794, including information regarding traffic and road conditions. The updates to the map information 794 may include updates for the HD map 722, such as information regarding construction sites, potholes, detours, flooding, and/or other obstructions. In some examples, the neural networks 792, the updated neural networks 792, and/or the map information 794 may have resulted from new training and/or experiences represented in data received from any number of vehicles in the environment, and/or based on training performed at a datacenter (e.g., using the server(s) 778 and/or other servers).

The server(s) 778 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 790, and/or the machine learning models may be used by the server(s) 778 to remotely monitor the vehicles.

In some examples, the server(s) 778 may receive data from the vehicles and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the vehicle 700. For example, the deep-learning infrastructure may receive periodic updates from the vehicle 700, such as a sequence of images and/or objects that the vehicle 700 has located in that sequence of images (e.g., via computer vision and/or other machine learning object classification techniques). The deep-learning infrastructure may run its own neural network to identify the objects and compare them with the objects identified by the vehicle 700 and, if the results do not match and the infrastructure concludes that the AI in the vehicle 700 is malfunctioning, the server(s) 778 may transmit a signal to the vehicle 700 instructing a fail-safe computer of the vehicle 700 to assume control, notify the passengers, and complete a safe parking maneuver.

For inferencing, the server(s) 778 may include the GPU(s) 784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

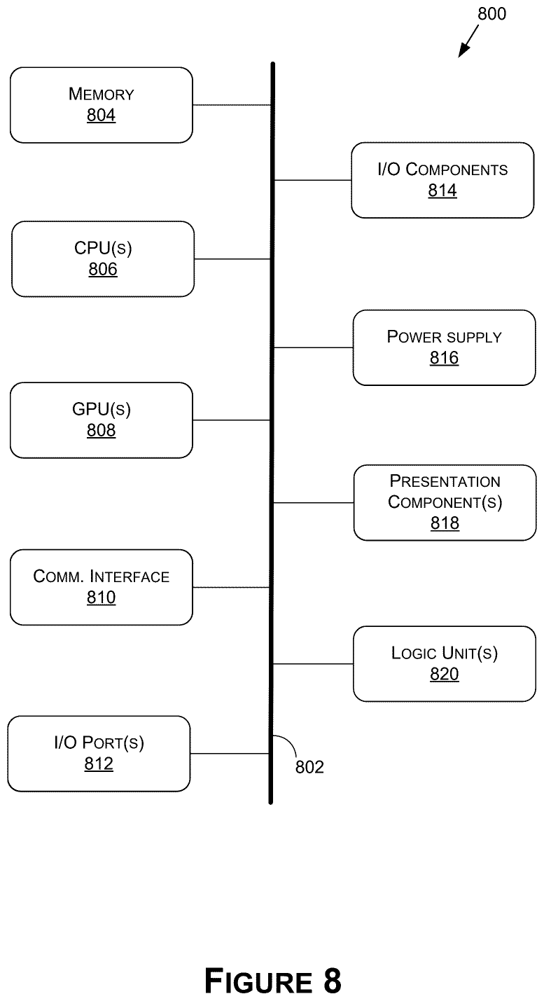

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface).

The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 933, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 933 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 933. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

One or more of the embodiments described below may be combined with one or more other embodiments or exist alone without any combining. In an example embodiment, one or more processors comprise one or more processing units to: receive data indicating movement, within a virtual scene, of one or more robotic components from a first position to a second position; generate, in a universal scene descriptor (USD) data format, delta information indicating one or more changes within the virtual scene based at least on the movement of the one or more robotic components; and store data corresponding to the delta information as at least part of a task definition for a robotic task.

In some embodiments, the one or more processing units are further to use the delta information and the task definition to at least one of: cause one or more real-world robotic components corresponding to the one or more robotic components to perform a task in a real-world environment; or train one or more real-world robots to perform the robotic task associated with the task definition.

In some embodiments, the one or more processing units are further to: generate, in the USD data format, second delta information indicating a change in movement based at least on one or more real-world robotic components representing the one or more robotic components performing a task in a scene represented by the virtual scene; and measure, by comparing the delta information with the second delta information, the task's adherence to the task definition.

In some embodiments, the generating of the delta information is based on at least one of: a natural language request issued by a user and processed by a language model or computer user input to a user interface.

In some embodiments, the USD data format corresponds to a 3D content collaboration platform for 3D assets used in OpenUSD.

In some embodiments, the delta information represents a delta layer, the delta layer containing only an indication of the one or more changes within the virtual scene and the delta layer excluding any indication of the virtual scene that has not been requested to be changed.

In some embodiments, the generation of the delta information is based at least on a user request that defines a number of delta layers to be generated or a cadence at which to generate delta layers between an initial state and a final state of the virtual scene corresponding to the robotic task.

In some embodiments, the virtual scene and the delta information are included in a file, and wherein the virtual scene represents a digital twin of a virtual robot that executes a virtual task in a virtual environment, and wherein the one or more processors are further to: provide one or more real-world robotic components the file as input, wherein the one or more real-world robotic components execute a real-world task in an environment represented by the virtual environment based on using the file as input.

In some embodiments, the one or more processors are further to train one or more robots in a simulation using the stored task definition.

In some embodiments, the one or more processors is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs); a system implemented using one or more multi-modal language models; a system incorporating one or more virtual machines (VMs); a system implemented at least partially in a data center; or a system implemented at least partially using cloud computing resources.

In an example embodiments, a system comprises one or more processors to: receive scene data representative of an environment, each element of the scene data being represented in a single format; receive a request to change a first portion of the scene data; and at least partially responsive to the receiving of the request to change the first portion of scene data, automatically generate a first delta layer, the first delta layer containing only an indication of the change to the first portion of the scene data and the first delta layer excluding any indication of the scene data that has not been requested to be changed.

In some embodiments, the change is representative of a task definition describing one or more actions that a robot needs to perform in order to complete a task, and wherein the one or more processing units are further to: in response to the robot performing the task in the environment, generate a second delta layer representative of the robot performing the task in the environment; and measure, by comparing the first delta layer with the second delta layer, the task's adherence to the task definition.

In some embodiments, the request to change the first portion of the scene data represents at least one of: a natural language request issued by a user and processed by a language model or computer user input at a user interface that at least partially represents the scene data.

In some embodiments, the scene data and the first delta layer correspond to a 3D content collaboration platform for 3D assets that uses OpenUSD.

In some embodiments, the change to the first portion of the scene data includes at least one of: a change in position of one or more objects in the first portion of the scene data, a change in velocity of the one or more objects in the first portion, a change in acceleration of the one or more objects in the first portion, a change in color of the one or more objects, a change in shape of the one or more objects, or a change in reflectivity of the one or more objects.

In some embodiments, the scene data at least partially represents a file that includes a digital twin of a virtual robot that executes a virtual task in a virtual environment, and wherein the one or more processors are further to: provide a real-world robot the file as input, wherein the robot executes a real-world task in the environment based on using the file as input.

In some embodiments, the scene data and the first delta layer are included in at least one of: a robotics application, a graphics rendering application, a gaming application, or an autonomous or semi-autonomous driving application.

In some embodiments, the system includes at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs); a system implemented using one or more multi-modal language models; a system incorporating one or more virtual machines (VMs); a system implemented at least partially in a data center; or a system implemented at least partially using cloud computing resources.

In some embodiments, a method comprises: generating scene data representative of a virtual environment, the scene data being generated using at least one of: one or more light transport algorithms, a three-dimensional (3D) content collaboration platform, simulated sensor data of one or more simulated sensors of a virtual or simulated machine within the simulation environment, or a platform to create one or more tasks for one or more robots; changing a first portion of the scene data based at least on one or more movements of the virtual or simulated machine; and based at least in part on the changing of the first portion of scene data, automatically generating a first delta layer, the first delta layer containing only an indication of the change to the first portion of the scene data and the first delta layer excluding any indication of the scene data that has not been changed.

In some embodiments, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs) a system implemented using one or more multi-modal language models; a system incorporating one or more virtual machines (VMs); a system implemented at least partially in a data center; or a system implemented at least partially using cloud computing resources.

What is claimed is:

1. One or more processors comprising one or more processing units to:
receive data indicating movement, within a virtual scene, of one or more robotic components from a first position to a second position;
generate, in a universal scene descriptor (USD) data format, delta information indicating one or more changes within the virtual scene based at least on the movement of the one or more robotic components; and
store data corresponding to the delta information as at least part of a task definition for a robotic task.

2. The one or more processors of claim 1, wherein the one or more processing units are further to use the delta information and the task definition to at least one of:
cause one or more real-world robotic components corresponding to the one or more robotic components to perform a task in a real-world environment; or
train one or more real-world robots to perform the robotic task associated with the task definition.

3. The one or more processors of claim 1, wherein the one or more processing units are further to:
generate, in the USD data format, second delta information indicating a change in movement based at least on one or more real-world robotic components representing the one or more robotic components performing a task in a scene represented by the virtual scene; and
measure, by comparing the delta information with the second delta information, the task's adherence to the task definition.

4. The one or more processors of claim 1, wherein the generating of the delta information is based on at least one of: a natural language request issued by a user and processed by a language model or computer user input to a user interface.

5. The one or more processors of claim 1, wherein the USD data format corresponds to a 3D content collaboration platform for 3D assets used in OpenUSD.

6. The one or more processors of claim 1, wherein the delta information represents a delta layer, the delta layer containing only an indication of the one or more changes within the virtual scene and the delta layer excluding any indication of the virtual scene that has not been requested to be changed.

7. The one or more processors of claim 1, wherein the generation of the delta information is based at least on a user request that defines a number of delta layers to be generated or a cadence at which to generate delta layers between an initial state and a final state of the virtual scene corresponding to the robotic task.

8. The one or more processors of claim 1, wherein the virtual scene and the delta information are included in a file, and wherein the virtual scene represents a digital twin of a virtual robot that executes a virtual task in a virtual environment, and wherein the one or more processors are further to:
provide one or more real-world robotic components the file as input, wherein the one or more real-world robotic components execute a real-world task in an environment represented by the virtual environment based on using the file as input.

9. The one or more processors of claim 1, wherein the one or more processors are further to train one or more robots in a simulation using the stored task definition.

10. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for implemented using one or more large language models (LLMs);
a system for implemented using one or more vision language models (VLMs);
a system implemented using one or more multi-modal language models;
a system incorporating one or more virtual machines (VMs);
a system implemented at least partially in a data center; or
a system implemented at least partially using cloud computing resources.

11. A system comprising one or more processors to:
receive scene data representative of an environment, each element of the scene data being represented in a single format;
receive a request to change a first portion of the scene data; and
at least partially responsive to the receiving of the request to change the first portion of scene data, automatically generate a first delta layer, the first delta layer containing only an indication of the change to the first portion of the scene data and the first delta layer excluding any indication of the scene data that has not been requested to be changed.

12. The system of claim 11, wherein the change is representative of a task definition describing one or more actions that a robot needs to perform in order to complete a task, and wherein the one or more processing units are further to:
in response to the robot performing the task in the environment, generate a second delta layer representative of the robot performing the task in the environment; and
measure, by comparing the first delta layer with the second delta layer, the task's adherence to the task definition.

13. The system of claim 11, wherein the request to change the first portion of the scene data represents at least one of: a natural language request issued by a user and processed by a language model or computer user input at a user interface that at least partially represents the scene data.

14. The system of claim 11, wherein the scene data and the first delta layer correspond to a 3D content collaboration platform for 3D assets that uses OpenUSD.

15. The system of claim 11, wherein the change to the first portion of the scene data includes at least one of: a change in position of one or more objects in the first portion of the scene data, a change in velocity of the one or more objects in the first portion, a change in acceleration of the one or more objects in the first portion, a change in color of the one or more objects, a change in shape of the one or more objects, or a change in reflectivity of the one or more objects.

16. The system of claim 11, wherein the scene data at least partially represents a file that includes a digital twin of a virtual robot that executes a virtual task in a virtual environment, and wherein the one or more processors are further to:
provide a real-world robot the file as input, wherein the robot executes a real-world task in the environment based on using the file as input.

17. The system of claim 11, wherein the scene data and the first delta layer are included in at least one of: a robotics application, a graphics rendering application, a gaming application, or an autonomous or semi-autonomous driving application.

18. The system of claim 11, wherein the system includes at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for implemented using one or more large language models (LLMs);
a system for implemented using one or more vision language models (VLMs);
a system implemented using one or more multi-modal language models;
a system incorporating one or more virtual machines (VMs);
a system implemented at least partially in a data center; or
a system implemented at least partially using cloud computing resources.

19. A method comprising:
generating scene data representative of a virtual environment, the scene data being generated using at least one of: one or more light transport algorithms, a three-dimensional (3D) content collaboration platform, simulated sensor data of one or more simulated sensors of a virtual or simulated machine within the simulation environment, or a platform to create one or more tasks for one or more robots;
changing a first portion of the scene data based at least on one or more movements of the virtual or simulated machine; and
based at least in part on the changing of the first portion of scene data, automatically generating a first delta layer, the first delta layer containing only an indication of the change to the first portion of the scene data and the first delta layer excluding any indication of the scene data that has not been changed.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for implemented using one or more large language models (LLMs);
a system for implemented using one or more vision language models (VLMs)
a system implemented using one or more multi-modal language models;
a system incorporating one or more virtual machines (VMs);
a system implemented at least partially in a data center; or
a system implemented at least partially using cloud computing resources.
